(19) United States
(12) Patent Application Publication
(10) Pub. No.: US 2023/0089043 A1
(43) Pub. Date: Mar. 23, 2023

(54) EDIBLE ANIMAL CHEWS

(71) Applicant: MARS, INCORPORATED, McLean, VA (US)

(72) Inventors: Matthew GOSLING, West Yorkshire (GB); Gareth THOMAS, West Yorkshire (GB)

(73) Assignee: MARS, INCORPORATED, McLean, VA (US)

(21) Appl. No.: 17/797,887

(22) PCT Filed: Feb. 10, 2021
(86) PCT No.: PCT/GB2021/050310

§ 371 Date: Aug. 5, 2022

(30) Foreign Application Priority Data
Feb. 10, 2020 (GB) 2001769.5

(51) Int. Cl. A23K 40/25; A23K 10/26; A23K 10/35; A23K 20/147; A23K 20/163; A23K 20/158; A23K 50/42

(52) U.S. Cl. CPC A23K 40/25; A23K 10/26; A23K 10/35; A23K 20/147; A23K 20/163; A23K 20/158; A23K 50/42

(57) ABSTRACT

The present disclosure relates to edible animal chews. Embodiment disclosed include an edible animal chew and processes for producing an edible animal chew comprising at least two extruded layers, wherein at least one extruded layer comprises: animal skin protein, wherein the animal skin is porcine or bovine, animal fat, wherein the animal fat is porcine or bovine, and soybean protein, wherein there is an air-gap between at least a portion of the at least two extruded layers, and a processes for forming an edible animal chew.

### BACKGROUND

Edible animal chews provide mental stimulation through occupation for domestic animals. Additionally, certain edible animal chews can provide health benefits for domestic animals, such has improved oral health.

Alternative, longer lasting, animal chews can be formed from animal hide (raw-hide), which requires no, or only minimal, processing. Despite providing longer chewing time, commercial exploitation of these animal-hide-based chews have several major drawbacks. These products have been linked to several cases of damage to teeth, intestinal damage and micro-bacterial poisoning. Furthermore, the inconsistent size, shape and properties of the rawhide, which are affected by the part of the animal hide being used, the quality of the butchering and subsequent processing, results in an inconstant product not suited to large scale commercialisation.

### BRIEF DESCRIPTION OF THE FIGURES

FIG. 1 shows an example of nozzle (1) in accordance with this disclosure. The nozzle has at least one extrusion channel (2), in this example, an outer concentric extrusion channel (2a) and an inner concentric circular extrusion channel (2b). The cross-sectional area of the outer concentric extrusion channel is smaller than the cross-sectional area of the inner concentric extrusion channel. The example nozzle comprises gas outlets (3) which are disposed between the extrusion channels at the distal end of the nozzle, and gas inlets (4). The nozzle may be used to form an edible animal chew as disclosed herein.

FIG. 2 shows a cross-section of an example edible animal chew (5) in accordance with this disclosure. The edible animal chew comprises at least two extruded layers (6) and has an air-gap (7) between the at least two extruded layers. In this case, the edible animal chew has an outer concentric extruded layer (8) and an inner concentric extruded layer (9). The cross-sectional area of the outer concentric extruded layer is smaller than the cross-sectional area of the outer concentric extruded layer. The edible animal chew may be produced using the process, nozzle and extrusion apparatus as disclosed herein.

FIG. 3 shows an example edible animal chew with a regular striped pattern.

FIG. 4 shows an example edible chew with a wrinkled pattern.

FIG. 5 shows an example edible animal chew that has a mottled pattern.

FIG. 6 shows the tensile test equipment (which can be used to determine tensile toughness) and samples. A) cutting press; B) ribbon (flat sheet) extrudate; C) a tensile bar cutting stamp [ISO 527-2; 75 mm long, 10 mm wide, 5 mm centre]; D) a tensile bar during texture analysis; and E) a tensile bar after analysis—the tensile bar is positioned within the grips of the tensile testing machine so that its full shoulder is exposed.

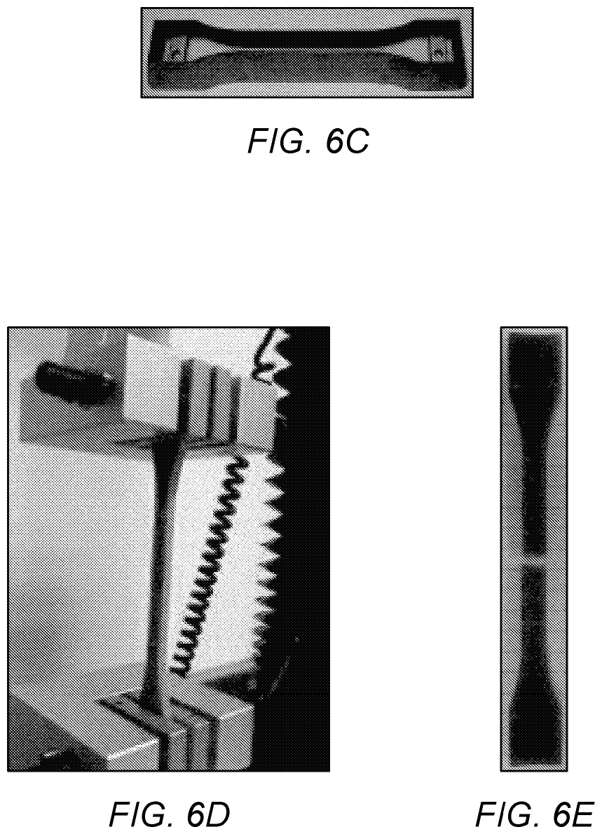

FIG. 7 shows a graphical representation of trends for cost, toughness, and instantaneous retarded springiness for potato starch, Drinde B95 SF (i.e. pork skin protein+pork fat), Clearam CO 01 (i.e. octenyl succinate modified starch) and soya fines (i.e. soy bean protein).

FIG. 8 shows a schematic of a texture profile analysis measurement.

FIG. 9 shows a general plot of the force response curve of a texture analysis test plotted on axes of stress (MPa) versus strain (%). The dimensions of the central break point (width and depth) are accounted for in the plot.

FIG. 10 shows a composition being extruded through a stainless steel nozzle.

FIGS. 11A and 11B shows the composition, from the end and along its length, respectively, that has been extruded through the nozzle of FIG. 10 and allowed to harden.

FIG. 12 shows a view of the base plate and test probe used for Texture Profile Analysis.

FIG. 13A and FIG. 13B show, respectively, (i) a graph of the composition hardness (Y-axis) against the wt % inclusion of potato starch, and (ii) a graph of the composition hardness (Y-axis) against the wt % inclusion of potato protein.

FIG. 14 shows a plot of the force responsive curve from a texture analysis test plotted on an axes of force (kg) over distance (mm).

### DETAILED DESCRIPTION

The presently-disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon.

All references to singular characteristics or limitations of the present disclosure shall include the corresponding plural characteristic(s) or limitation(s) and vice versa, unless otherwise specified or clearly implied to the contrary by the context in which the reference is made.

All embodiments herein are intended to be readily combined, unless otherwise specified or clearly implied to the contrary by the context in which the referenced combination is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the statements. Thus, for example, reference to “an animal chew” may include a plurality of such animal chews, and so forth.

Unless otherwise indicated, all numbers expressing quantities, properties, and so forth used in the specification and statements are to be understood as being modified in all instances by the term “about”. Accordingly, unless indicated to the contrary, the numerical parameters set forth in this specification and statements are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±15%, in some embodiments ±10%, in some embodiments ±5%, in some embodiments ±1%, in some embodiments ±0.5%, and in some embodiments ±0.1% from the specified amount, as such variations are appropriate to perform the disclosed invention(s).

All measurements herein are measured under standard conditions unless stated otherwise. All measurements referred to herein refer to the mean average, unless stated otherwise.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units is also disclosed. For example, if 10 and 15 are disclosed, then 11, 12, 13, and 14 are also disclosed.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

As used herein, “pet food” means a composition intended for oral consumption to meet one or more nutritional needs of a pet. Pet food expressly excludes items that are capable of being orally ingested but are not intended to be ingested, such as rocks. The terms “pet food” and “pet food product” are used interchangeably throughout this disclosure. A pet food may be, for example, in certain embodiments, a treat, a chew, a biscuit, a gravy, a supplement, a topper and any combination thereof.

As used herein, “dietary composition” refers to any composition utilized as part of the diet for a dog. This includes, but is not limited to, a pet food, a treat, a chew, a biscuit, a gravy, a supplement, a topper, and any combination thereof.

As used herein, “nutritionally balanced” and/or “nutritionally complete” refers to a composition capable of sustaining life as the sole dietary ration for an animal, without the need for any other substance, except possibly water.

As used herein, the terms “animal” or “pet” mean an animal including, but not limited to a domestic animal and livestock. An animal can include, without limitation, a domestic dog, cat, horses cow, ferret, rabbit, pig, or the like. Domestic dogs and cats are particular examples of pets. “Dog” includes dogs under 1 year of age as well as adult dogs, between 1 year of age and 7 years of age; seniors, older than 7 years of age; and super-seniors, older than 11 years of age.

As used herein, “water activity” is a measurement of the energy status of the water in a system; represented by a quotient between water's partial pressure in the food and pure water's partial pressure. It indicates how tightly water is bound, structurally or chemically, within a substance.

This is measured by equilibrating the liquid phase (in the sample) with the vapour phase (in the headspace) and measuring the relative humidity of that space. Water activity may be measured using a chilled-mirror dewpoint technique, apparatus for making such measurements are commercial available (e.g. AQUA LAB 4TEV—which has ±0.003 a_{w} accuracy).

As used herein, the term “animal chew” or “edible animal chew” may be considered to be any snack and/or treat for an animal. It should be noted that an animal “chew” is quite distinct from an animal food or pet food. An animal chew differs from an animal food in at least the size of the pieces, the time taken for the animal to consume each piece, in the number of pieces per serving and/or in nutritional content.

As used herein, the term “porcine” refers to material from pig.

As used herein, the term “bovine” refers to material from cow.

As used herein, the term “animal skin protein” refers to protein that derives from the skin of an animal. Animal skin protein comprises collagen, which may be any type of collagen, most typically, type I and type III collagen. Animal skin proteins may also include keratin, laminin, fibronectin and filaggrin.

As used herein, “collagen” is a protein which in its natural state comprises aggregates (fibrils) of tropocollagen. Tropocollagen molecule comprises a triple helix of protein chains (polypeptide strands). Collagen is the main structural protein found in connective tissues of animals. “Collagen” as described herein includes native collagen and/or chemically modified collagen.

As used herein, “soybean” refers to the species of legume Glycine max. Soybean is otherwise known as soya bean, and soy bean and soya bean may be used interchangeably herein.

As used herein, “soy bean protein” refers to any protein isolated from soybean. Soybean proteins are taken to include glycinin and beta-conglycinin

As used herein, “soy bean meal” refers to the by-product of oil extraction from soybean seeds, in other words, soybeans with oil removed. Soybean meal may have been additionally treated, for example, by heating to denature certain enzymes such as trypsin.

As used herein, “potato” refers to the tuber of the plant Solanum tuberosum.

As used herein, “potato protein” refers to any protein isolated from potato. Potato protein typically includes the protein tuberine, and this can be present in potato protein in an amount of at least 50 wt %. Tuberine can be fractionated into albumin and globulin. The potato protein may comprise proteins selected from albumin, globulin, prolamine and glutelin. Potato protein may comprise at least 40 wt % albumin, at least 20 wt % globulin, and least 1 wt % prolamine, at least 5 wt % glutelin, with the balance of the potato protein being other proteins extracted from potato.

As used herein, “size” in reference to a “particle size” refers to the diameter of a particle.

As used herein “d₅₀” refers to the particle size wherein 50% (typically by weight) of the particle distribution has a smaller size, and 50 percent of the particle distribution has a larger size. The particle size may be determined by sieve analysis, for example, sieve analysis in accordance with ASTM C136/C136 M.

As used herein “d₉₀” refers to particle size wherein 90% (typically by weight) of the particle distribution has a smaller size, and 10 percent of the particle distribution has a larger size. The particle size may be determined by sieve analysis, for example, sieve analysis in accordance with ASTM C136/C136 M.

As used herein, “lasting time” refers to the amount of time taken for an animal to consume the edible animal chew, in some examples, a dog.

As used herein, “SME” refers to specific mechanical energy which is the mechanical energy of an object per unit of mass.

As used herein, “extrusion composition” refers to the mixture of components that is extruded to form at least one extruded layer. The term extrusion composition may be used interchangeably with ‘extrusion mixture’. “Extruded composition” refers to the composition that has been extruded. All disclosures relating to (e.g. content of) the extrusion composition are equally applicable to the extruded composition, and vice versa.

As used herein, “concentric” refers to an arrangement of two or more objects (for example, extrusion channels or layers) wherein the two or more objects share the same centre or axis. Each object may or may not have a regular geometric shape. For example, if the object is extruded, the axis of the object may be the direction along which the object was extruded during production, and the object may have an irregular shape in cross-section; however, the two or more objects (e.g. layers) may be disposed partially or completely concentrically to one another, i.e. with one closer to the approximate centre than the other (or, conversely, with one layer being disposed closer to an outer surface of the edible animal chew than the other).

As used herein, “substantially free” in reference to a substance or a particular component means that a composition or object comprises less than 0.5 wt. %, or less than 0.1 wt. %, or less than 0.05 wt. % of that substance or component.

As used herein, “air gap” and “gap” are used interchangeably herein to refer to a gaseous space between the at least two layers of a material, such as an extruded material. In some embodiments, an air gap can be a continuous space between layers, and in other embodiments an air gap can be comprised of one or more spaces between layers. The gaseous space may be filled by air, or any other gaseous component (e.g. a gas that may have been injected in an extrusion process).

As used herein, “layer” refers to one part of the extruded material which is physically distinct from another part of the extruded material, for example where two parts of the material have been extruded from different parts of a nozzle; the layers, in the final product, may be in contact with one another or separated from one another, e.g. with the air gap as described herein. The at least two extruded layers may be arranged in any suitable way, for example, linearly (e.g. in sheets), concentrically, helically or radially.

As used herein, “crescent” refers to any curved shape that is broader in its centre and tapers to a point at each end.

All lists of items, such as, for example, lists of ingredients, are intended to and should be interpreted as Markush groups. Thus, all lists can be read and interpreted as items “selected from the group consisting of” . . . list of items . . . “and combinations and mixtures thereof.”

All percentages in the present disclosure are listed as percent by weight on the total weight of the material or mixture, unless explicitly noted otherwise.

The present disclosure provides an edible animal chew comprising a composition comprising
animal skin protein, wherein the animal skin is porcine or bovine,
animal fat, wherein the animal fat is porcine or bovine, and
a plant protein selected from soybean protein and potato protein,
and optionally starch. The composition may be an extruded composition. It may be formed from the extrusion compositions described herein (and contain the same components in the same amounts). The composition may be in any form allowed by an extrusion process. The composition may be present with other edible compositions. The composition may be in the form of a layer, optionally, with one or more other layers of edible compositions, which may be the same as or different to one another in content.

The present disclosure provides an edible animal chew comprising at least two extruded layers, wherein at least one extruded layer comprises: animal skin protein, wherein the animal skin is porcine or bovine, animal fat, wherein the animal fat is porcine or bovine, and a plant protein selected from soybean protein and potato protein, wherein there is an air-gap between at least a portion of the at least two extruded layers.

The present disclosure provides an edible animal chew comprising
an extruded composition comprising:
animal skin protein, wherein the animal skin is porcine or bovine,
animal fat, wherein the animal fat is porcine or bovine, and
a plant protein selected from soybean protein and potato protein,
and starch. The animal skin protein and animal fat together may constitute at least 10 wt % of the extruded composition. The plant protein may constitute at least 10 wt % of the extruded composition. The starch may constitute at least 10 wt % of the extruded composition.

The present disclosure provides an edible animal chew comprising
an extruded composition comprising:
animal skin protein, wherein the animal skin is porcine or bovine,
animal fat, wherein the animal fat is porcine or bovine, and
a plant protein selected from soybean protein and potato protein,
and starch, wherein
the animal skin protein and animal fat together constitute at least 10 wt % of the extruded composition,
the plant protein constitutes at least 10 wt % of the extruded composition, and
the starch constitutes at least 10 wt % of the extruded composition.

The present disclosure provides a process for producing an edible animal chew, the process comprising extruding a composition comprising
animal skin protein, wherein the animal skin is porcine or bovine,
animal fat, wherein the animal fat is porcine or bovine, and
a plant protein selected from soybean protein and potato protein,
and optionally starch. The composition may be as described herein and have the content of components as described herein.

The present disclosure provides a process for producing an edible animal chew, the process comprising extruding a composition, which may be termed an extrusion composition, comprising
animal skin protein, wherein the animal skin is porcine or bovine,
animal fat, wherein the animal fat is porcine or bovine, and
a plant protein selected from soybean protein and potato protein,
and optionally starch.

The present disclosure provides a process for producing an edible animal chew, the process comprising extruding a composition, which may be termed an extrusion composition, the composition comprising
animal skin protein, wherein the animal skin is porcine or bovine,
animal fat, wherein the animal fat is porcine or bovine, and
a plant protein selected from soybean protein and potato protein,
and starch, wherein
the animal skin protein and animal fat together constitute at least 10 wt % of the extrusion composition,
the plant protein constitutes at least 10 wt % of the extrusion composition, and
the starch constitutes at least 10 wt % of the extrusion composition.

Also provided herein is a composition, which may be an extrusion composition or an extruded composition, wherein the composition comprises
animal skin protein, wherein the animal skin is porcine or bovine,
animal fat, wherein the animal fat is porcine or bovine, and
a plant protein selected from soybean protein and potato protein,
and optionally starch.

Also disclosed herein is an edible chew producible by the process described herein.

In a first aspect, there is provided an edible animal chew comprising at least two extruded layers, wherein at least one extruded layer, optionally each of the at least two extruded layers, comprises:

animal skin protein, wherein the animal skin is porcine or bovine,
animal fat, wherein the animal fat is porcine or bovine, and
soybean protein,
and wherein there is an air-gap between at least a portion of the at least two extruded layers.

In a second aspect, there is provided a process for producing an edible animal chew comprising at least two extruded layers, comprising:
extruding at least one extrusion composition to form at least two extruded layers,
wherein at least one extrusion composition comprises animal skin protein, animal fat and soybean protein and
injecting a gas between the at least two extruded layers to form a gap
between at least a portion of the two extruded layers, and
wherein the animal skin is porcine or bovine and wherein the animal fat is porcine or bovine.

Also disclosed herein is a process for producing an edible animal chew comprising at least two extruded layers, comprising:
extruding at least one extrusion composition to form at least two extruded layers,
wherein at least one extrusion composition comprises animal skin protein, animal fat and a plant protein selected from soybean protein and potato protein, and
injecting a gas between the at least two extruded layers to form a gap
between at least a portion of the two extruded layers, and
wherein the animal skin is porcine or bovine and wherein the animal fat is porcine or bovine.

In a third aspect, there is provided an edible chew producible by the process according to the second aspect.

Herein is also disclosed, in a first example, a nozzle for an extrusion process, comprising at least one extrusion channel that is configured to form at least two extruded layers and at least one gas outlet configured to inject gas between the at least two extruded layers.

Herein is also disclosed, in an second example, an extrusion apparatus comprising an extruder comprising a nozzle, the nozzle, comprising:

at least one extrusion channel that is configured to form at least two extruded layers, and at least one gas outlet configured to inject gas between the at least two extruded layers, wherein the gas outlet is connected to a gas supply.

Herein is also disclosed, in a third example, a process for producing an edible animal chew comprising at least two extruded layers, comprising:

extruding at least one extrusion composition to form the at least two extruded layers; and injecting a gas between the at least two extruded layers to form a gap between at least a portion of the two extruded layers. In some examples, the at least one extrusion composition comprises a mixture of animal skin protein, animal fat and soybean protein, wherein the animal skin is porcine or bovine and wherein the animal fat is porcine or bovine.

Herein is also disclosed, in a fourth example, is a process for producing an edible chew according to the third example using the nozzle according to the first example.

Herein is also disclosed, in a fifth example, a process for producing an edible chew according to the third example using the extrusion apparatus according to the second example.

The present inventors found that, while animal skin protein can assist in creating animal chews with high toughness, there is a disadvantage in using it, particularly in extruded products, and especially in extruded products with at least two extruded layers. In an extruded product, the starting materials are typically passed through a heated extruder. However, animal skin protein, comprising collagen, melts at a relatively low temperature, resulting in a composition with low viscosity. Similarly, a number of commercial animal skin protein products contain a relatively high amount of fat which also contributes to the low viscosity of the composition in an extruder. This makes the composition difficult to extrude, and the extruded composition may be unable to keep its extruded shape while in a heated state, e.g. if extruding in layers, the extruded layers may collapse onto one another.

An embodiment of the edible animal chews described herein comprises animal skin protein, animal fat and a protein selected from soybean protein and potato protein. An embodiment of the edible animal chews described herein comprises at least two extruded layers, wherein at least one extruded layer comprises animal skin protein, animal fat and soybean protein. Potato protein may be used instead of or in addition to the soybean protein. The edible animal chews described herein were found to have good physical properties in comparison to previous edible animal chews, since they had a high tensile toughness and a good lasting time. Furthermore, the composition of the edible animal chews herein has good viscoplastic properties, which (i) enables the edible animal chew to be easily extruded, and (ii) allows the extruded layers to keep their shape, and not collapse, after extrusion, even when the composition has been heated. The edible animal chews described herein also have a low water activity and are therefore microbiologically safe.

The processes, nozzle and extrusion apparatus described herein can be used to form edible animal chews with distinct patterns that have aesthetic appeal. In particular, the processes, nozzle and edible apparatus described herein can be used to form edible animal chews comprising at least two extruded layers, wherein there is an air-gap between at least a portion of the at least two extruded layers. The air-gap is formed by injecting a gas between the at least two extruded layers, for example, as the extrusion composition leaves the extrusion apparatus. Portions of the at least two extruded layers with an air-gap between the layers may have a lighter tone than portions of the at least two extruded layers wherein the layers are in contact. The amount and periodicity of gas that is injected between the layers can therefore be controlled to generate edible animal chews that have different patterns. In some examples, e.g. when extruding the composition with a nozzle comprising two concentric extrusion channels, gas may be injected at a low pressure (e.g. 0.1 to 0.4 bar) or a higher pressures (e.g. 0.5 to 3 bar) to generate an edible animal chew with either a mottled pattern or wrinkled pattern respectively. The nozzle and apparatus may also been designed, such that the at least two extruded layers are extruded through different portions of an extruded channel, wherein the different portions have a different cross-sectional area. This may cause one of the extruded layers to be extruded at a smaller pressure (i.e. compared to one or more other extruded layers), causing the extruded layer to slow or bunch, resulting in an edible chew with a regular striped pattern.

In an embodiment, the processes, nozzle and apparatus described herein can be used to form edible animal chews wherein the extrusion composition as described herein is extruded, optionally with another composition. The extrusion composition may, for example, be in the form of a hollow tube, optionally with an edible composition forming a filling in the tube.

### Edible Animal Chew

The edible animal chew may be suitable for any animal or pet. The edible animal chew may be suitable for any animal that enjoys chewing on rawhide. In an embodiment, the animal is a carnivorous mammal, for example, a cat or a dog.

In an embodiment, the edible animal chew comprises at least two extruded layers with an air-gap between at least a portion of the at least two extruded layers. In an embodiment, the edible animal chew comprises at least two extruded layers with an air-gap between at least 5%, or at least 10%, or at least 20%, or at least 30%, or at least 40%, or at least 50%, or at least 60%, or at least 70%, or at least 80%, or at least 90% or at least 95%, or entirely between (i.e. at least 100%) of the at least two extruded layers. In an embodiment, the edible animal chew comprises at least two extruded layers with an air-gap between 5% to 95% the at least two extruded layers.

The air-gap may have any suitable distance between the at least two extruded layers. In an embodiment, the air-gap has an average distance of from 0.05 cm to 3 cm between the at least two extruded layers, preferably an average distance of from 0.1 cm to 0.5 cm between the at least two extruded layers.

Portions of the edible animal chew with an air-gap between the at least two extruded layers may have a different appearance to portions of the edible animal with no air-gap between the at least two extruded layers, in other words, wherein the two extruded layers are in contact. Portions of the edible animal chew with an air-gap between the at least two extruded layers may have a lighter tone or appearance as compared to portions of the at least two extruded layers that do not contain an air-gap. Portions of the edible chew with an air-gap between the at least two extruded layers may have a regular or irregular pattern. Portions of the edible chew with an air-gap between the at least two extruded layers may have a symmetrical or anti-symmetrical pattern. In an embodiment, the at least two extruded layers may have a pattern selected from a striped pattern, a spotted pattern, a spiral pattern, a wave pattern, a foam or bubbled pattern, a spotted pattern, a mottled pattern, and a wrinkled pattern, and any combination thereof.

The process for producing the edible animal chew described herein may be used to control the relative portions of the edible animal chew that have an air-gap between the at least two extruded layers and the relative portions of the edible animal chew that do not have an air-gap between the at least two extruded layers. This can be used to create edible animal chews with different patterns, thus improving their overall aesthetic appeal.

The edible animal chew preferably has two layers, but may have, three, four, five, six, seven, eight, nine, or ten or more layers.

In some embodiments, each of the at least two extruded layers comprises: the animal skin protein, wherein the animal skin is porcine or bovine, and animal fat, wherein the animal fat is porcine or bovine, and a protein selected from soybean protein and potato protein, and optionally starch. In some embodiments, each of the at least two extruded layers comprises: the animal skin protein, wherein the animal skin is porcine or bovine, and animal fat, wherein the animal fat is porcine or bovine, and protein selected from soybean protein and potato protein. While each of the extruded layers comprise the animal skin protein, the animal fat and the plant protein selected from the soybean protein and potato protein, the animal skin protein, the animal fat and the plant protein selected from soybean protein and potato protein may be present in the same or different proportions in each layer. For example, in some embodiments, the at least two extruded layers have the same composition, e.g. in that the at least two extruded layers each comprise the animal skin protein, the animal fat and the protein selected from soybean protein and potato protein in the same wt./wt. proportions, and, wherein any other optional components (e.g. starch, water and/or plasticiser) are present in each layer in the same wt/wt proportions. In these embodiments, ‘at least one extruded layer’ may be used interchangeably with the ‘at least two extruded layers’, with reference to the composition and amounts. In other embodiments, the at least two extruded layers may have a different composition, for example, the animal skin and/or animal fat and/or soybean protein are present in each layer in different wt/wt components, and optionally, wherein any other components (e.g. starch, water and/or plasticiser) are present in each layer in the same or different wt/wt proportions.

In alternative embodiments, the at least one extruded layer comprises animal skin protein, animal fat, and a plant protein selected from soybean protein and potato protein, and at least a second extruded layer comprises a different material, which may be any material that can be extruded and is suitable for use in an edible animal chew. In alternative embodiments, the at least one extruded layer comprises animal skin protein, animal fat, and soybean protein, and at least a second extruded layer comprises a different material, which may be any material that can be extruded and is suitable for use in an edible animal chew. This may be beneficial for reasons of cost and/or ease of extrusion. The different material may comprise components selected from a polysaccharide, a protein or a combination thereof. The polysaccharide may be selected from a native starch, a modified starch, cellulose, dextrin, maltodextrin or a combination thereof. In some embodiments, the protein may be an animal protein, for example, selected from collagen, modified collagen, partially hydrolysed collagen, gelatin, casein, whey protein, albumin or fibrin. In some embodiments, the protein may be a vegetable protein, for example, selected from wheat gluten, zein protein, pea protein, nut protein, corn protein, soy bean protein, oat protein or a combination thereof. In some embodiments, the different material may comprise one or more further additives which may be selected from gums, gelling agents, water, glycerol, salt, and/or flavourings. The different material may be substantially free of animal skin protein and/or animal fat and/or the plant protein selected from the soybean protein and potato protein. In some embodiments, the different material may be animal meal, a gel, thick gravy, cream or a meat emulsion.

The at least one extruded layer or the extruded composition may be in the form of a hollow tube, with a different material, which may be as described above, forming a filling in the tube. In the context of the present application, a filling in a tube may constitute a layer, and the hollow tube may constitute another layer. The filling may be coextruded by extruding the extrusion composition and filling material simultaneously through one or more dies so that they form separate layers, or the filling may be injected into the hollow tube or filled in another way, such as during or after extrusion of the hollow tube. The different material may comprise components selected from a polysaccharide, a protein or a combination thereof. The polysaccharide may be selected from a native starch, a modified starch, cellulose, dextrin, maltodextrin or a combination thereof. In some embodiments, the protein may be an animal protein, for example, selected from collagen, modified collagen, partially hydrolysed collagen, gelatin, casein, whey protein, albumin or fibrin. In some embodiments, the protein may be a vegetable protein, for example, selected from wheat gluten, zein protein, pea protein, nut protein, corn protein, soy bean protein, oat protein or a combination thereof. In some embodiments, the different material may comprise one or more further additives which may be selected from gums, gelling agents, water, glycerol, salt, and/or flavourings. The different material may be substantially free of animal skin protein and/or animal fat and/or the plant protein selected from the soybean protein and potato protein. In some embodiments, the different material may be animal meal, a gel, thick gravy, cream or a meat emulsion. In an embodiment, the different material, which may form the filling, may comprise protein, which may comprise animal and/or plant protein (e.g. protein from an animal organ, such as liver, meal and/or a plant protein such as pea protein), starch, which may be selected from wheat starch, potato starch and pea starch, liquid (which may be selected from water and a plasticiser, such as glycerol), and optionally one or more additives, which may function to enhance flavour, smell and/or texture of the composition and/or as preservatives in the composition (e.g. the additives may be selected from a mineral filler, such as calcium carbonate, a colouring agent, an anti-oxidant, salt, sugar, and an anti-microbial agent). The different material may be softer than or have a lower viscosity than the extruded layer or extruded composition.

The edible animal chew may have any suitable size or shape. In an embodiment, the edible animal chew is an elongate edible animal chew. The elongate edible animal chew may have a length, which is along the longest dimension of the animal chew, and a cross section, perpendicular to the length, and the shape of the cross section may be substantially constant along the length of the animal chew. In an embodiment, the edible animal chew has a longest dimension of at least about 0.5 cm, or at least about 1 cm, or at least about 2.5 cm, or at least about 5 cm, or at least about 7 cm, optionally at least about 10 cm, optionally at least about 15 cm, optionally at least about 30 cm. In an embodiment, the edible animal chew has a cross-sectional length from about 0.5 cm to about 30 cm in its longest dimension, preferably from about 2 cm to about 15 cm. In an embodiment, the edible animal chew has a cross-sectional width from about 0.5 cm to about 6 cm in its longest dimension, preferably from about 1.5 cm to about 5.5 cm.

The cross-sectional shape of the animal chew may be any regular or irregular shape. The cross-sectional shape may be selected from a circle, an oval, a rounded shape, or an n-sided regular shape, and optionally n is selected from 3 to 12, optionally 4, 5, 6 or 7, 8, 9, 10 or 11. The shape may, for example, be selected from, but not limited to, a triangle, a square, a rectangle, a hexagon, a heptagon, an octagon, or a star.

The at least two extruded layers may have any suitable thickness. In an embodiment, the at least two extruded layers each have a thickness from about 0.01 cm to about 1.0 cm, preferably from about 0.1 cm to about 0.5 cm. In some embodiments the at least two extruded layers have the same thickness. In other embodiments, the at least two extruded layers have the same thickness. Extruded layers having a different thickness may result in the edible animal chew having a regular striped pattern, as a result of the extrusion process. Due to differences in pressure during the extrusion process (due to the differences in the cross-sectional size of the two portions of an extrusion channel, or two different extrusion channels), the thicker extruded layer may slow or bunch after leaving the extrusion apparatus or nozzle. This may cause the cause at least a portion of the thicker extruded layer to come into contact with the thinner extruded layer.

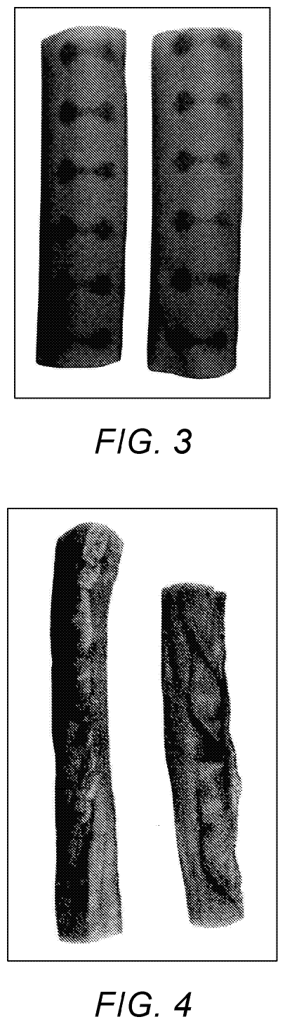

In an embodiment, the at least two extruded layers comprise at least an outer concentric layer and an inner concentric layer (e.g. as shown in FIG. 3). The outer concentric layer has a larger cross-sectional width in its largest direction than the inner concentric layer. The outer concentric layer and the inner concentric layer may have the same or a different thickness. The outer concentric layer may have a thickness of about 0.01 cm to about 1.0 cm, or about 0.2 cm to about 1.0 cm, preferably about 0.1 cm to about 0.5 cm. The inner concentric layer may have a thickness of about 0.01 cm to about 1.0 cm, or about 0.2 cm to 1.0 cm, preferably about 0.1 cm to about 0.5 cm. In a preferred embodiment, the outer concentric layer has a smaller thickness than the inner concentric layer (e.g. as shown in FIG. 3).

In an embodiment, the outer concentric layer and the inner concentric layer have a circular cross-section. The outer circular concentric layer may have an average diameter from about 1.5 cm to about 5.5 cm, preferably from about 1.7 cm to about 3 cm. The inner circular concentric layer may have an average diameter from about 0.5 cm to about 4 cm, preferably from about 0.7 cm to about 2.5 cm. In other embodiments, the outer concentric layer and the inner concentric layer may have another cross-sectional shape, which may be selected from, but not limited to, an oval, triangle, square, rectangle, hexagon, heptagon, octagon, or a star.

In an embodiment, the outer concentric layer and the inner concentric layer have the same composition. In an embodiment, the outer concentric layer and the inner concentric layer comprise a different composition, for example, the outer concentric layer may comprise animal skin protein, soy bean protein and animal fat, wherein the animal skin is porcine or bovine and the animal fat is porcine or bovine, and the inner concentric layer may comprise a different material (e.g. as described above).

### Animal Skin Protein

The at least one extruded layer or at least two extruded layers and/or at least one extrusion composition, and/or the extruded composition, comprises animal skin protein. The animal skin protein is porcine or bovine, preferably porcine. In a preferred embodiment, the animal skin protein derives from pork rind or a pork rind component.

The at least one extruded layer or at least two extruded layers and/or at least one extrusion composition, and/or the extruded composition, may comprise animal skin protein in any suitable amount. In an embodiment, at least one extruded layer or at least two extruded layers and/or at least one extrusion composition, and/or the extruded composition, may comprise about 5 wt. % to about 50 wt. %, or about 6 wt. % to about 48 wt. %, or about 7 wt. % to about 47 wt. %, or preferably about 7 wt. % to about 45%, or preferably about 7 wt. % to about 37%, or preferably about 8 wt. % to about 32 wt. %, or preferably about 9 wt. % to about 30 wt. %, or preferably about 11 wt. % to about 27 wt. %, or preferably about 15 wt. % to about 27 wt. %, or preferably about 18 wt. % to about 27 wt. %, or preferably about 18 wt. % to about 25 wt. %, or preferably about 18 wt. % to about 23 wt. % animal skin protein. In an embodiment, at least one extruded layer or at least two extruded layers and/or at least one extrusion composition, and/or the extruded composition, may comprise about 5 wt. %, or greater than about 6 wt. %, or greater than about 8 wt. %, or greater than about 10 wt. %, or greater than about 12 wt. %, or greater than about 14 wt. %, or greater than about 17 wt. % animal skin protein. In an embodiment, the at least one extruded layer or at least two extruded layers and/or at least one extrusion composition, and/or the extruded composition, may comprise less than about 50 wt. %, or less than about 45 wt. %, or less than about 39 wt. %, or less than about 36 wt. %, or less than about 31 wt. %, or less than about 29 wt. %, or less than about 27 wt. %, or less than about 24 wt. % animal skin protein.

The animal skin protein comprises collagen. The animal skin protein may comprise at least 40 .wt %, or at least 50 wt. %, or at least 60 wt. %, or at least 70 wt. %, or at least 75 wt. %, or at least 80 wt. %, or at least 85 wt. %, or at least 90 wt. %, or at least 95% collagen, or at least 99% collagen. In some embodiments, the animal skin protein may consist entirely of collagen. In some embodiments, the animal skin protein may comprise between 40 wt. % and 99 wt. % collagen, or from 60 wt. % to about 85 wt. % collagen. The animal skin protein may further comprise at least one of keratin, laminin, fibronectin and filaggrin or a combination thereof.

In an embodiment, the at least one extruded layer and/or at least one extrusion composition, and/or the extruded composition, may comprise about 7 wt. % to about 37 wt. %, or from about 8 wt. % to about 30 wt. %, or preferably from about 11 wt. % to about 24 wt. %, or preferably from about 18 wt. % to about 21 wt. % collagen. In an embodiment, the at least one extruded layer or at least two extruded layers and/or at least one extrusion composition, and/or the extruded composition, may comprise greater than about 5 wt. %, or greater than about 6 wt. %, or greater than about 7 wt. %, or greater than about 8 wt. %, or greater than about 9 wt. %, or greater than about 10 wt. %, or greater than about 11 wt. %, or greater than about 12 wt. %, or greater than about 13 wt. %, or greater than about 14 wt. %, or greater than about 15 wt. %, or greater than about 16 wt. %, or greater than about 17 wt. % collagen. In an embodiment, the at least one extruded layer or at least two extruded layers and/or at least one extrusion composition, and/or the extruded composition, may comprise less than about 40 wt. %, or less than about 35 wt. %, or less than about 30 wt. %, or less than about 25%, or less than about 22 wt. % collagen.

In some examples, the animal skin protein is responsible for high tensile toughness in the final product. The animal skin protein, which comprises fibrous collagen, is resistant to breaking down during chewing. This results in an edible animal chew with a long lasting or chewing time.

### Animal Fat

The at least one extruded layer or at least two extruded layers and/or at least one extrusion composition, and/or the extruded composition, comprises animal fat. The animal fat is porcine or bovine, preferably porcine. In a preferred embodiment, at least a portion of the animal fat derives from pork rind. In some embodiments, the animal fat derives from pork rind cooked in fat, preferably animal fat, for example, pork fat.

The at least one extruded layer or at least two extruded layers and/or at least on extrusion composition, and/or the extruded composition, may comprise animal fat in any suitable amount. In an embodiment, the at least one extruded layer or at least two extruded layers and/or at least one extrusion composition, and/or the extruded composition, comprises from about 0.25 wt. % to about 15 wt. %, or from about 0.3 wt. % to about 10 wt. %, or from about 0.4 wt. % to about 9 wt. %, or preferably from about 0.5 wt. % to about 8 wt. %, or preferably from about 1 wt. % to about 6 wt. %, or more preferably from about 1.5 wt. % to about 5 wt. %, or even more preferably from about 2 wt. % to about 4.5 wt. % animal fat. In an embodiment, the at least one extruded layer or at least two extruded layers and/or at least one extrusion composition, and/or the extruded composition, comprises greater than about 0.25 wt. %, or greater than about 0.5 wt. %, or greater than about 1 wt. %, or greater than about 1.5 wt. %, or greater than about 2 wt. % animal fat. In an embodiment, the at least one extruded layer or at least two extruded layers and/or at least one extrusion composition, and/or the extruded composition, comprises less than about 15 wt. %, or less than about 12 wt. %, or less than about 10 wt. %, or less than about 8 wt. %, or less than about 6 wt. %, or less than about 5 wt. % animal fat, or less than about 4 wt. %, or less than about 3 wt. %, or less than about 2 wt. % animal fat.

In some embodiments, the animal skin protein and the animal fat both derive from a pork rind and/or a cow hide component. The pork rind or cow hide component may have been cooked in the presence of additional animal fat. In an example, a pork rind component is used, which has been cooked in the presence of pork fat. In an example, the pork rind component comprises about 60 wt. % to about 70 wt. % collagen and about 7% to about 15% animal fat.

The at least one extruded layer or at least two extruded layers and/or at least one extrusion composition, and/or the extruded composition, comprises the pork rind and/or cow hide component in any suitable amount. In some embodiments, the at least one extruded layer or at least two extruded layers and/or at least one extrusion composition, and/or the extruded composition, comprises about 8 wt. % to about 65 wt. %, or from about 10 wt. % to about 60 wt. %, or preferably from about 13 wt. % to about 52 wt. %, or preferably from about 17 wt. % to about 45 wt. %, or preferably from about 20 wt. % to about 40 wt. %, or even more preferably from about 25% to about 35% pork rind and/or cow hide component. In some embodiments, the at least one extruded layer or at least two extruded layers and/or at least one extrusion composition, and/or the extruded composition, comprises greater than about 8 wt. %, or greater than about 12 wt. %, or greater than about 18 wt. %, or greater than about 22 wt. %, or greater than about 25 wt. %, or greater than about 29 wt. % pork rind and/or cow hide component. In some embodiments, the at least one extruded layer or at least two extruded layers and/or at least one extrusion composition, and/or the extruded composition, comprises less than about 70 wt. %, or less than about 65 wt. %, or less than about 60 wt. %, or less than about 55 wt. %, or less than about 50 wt. %, or less than about 45 wt. %, or less than about 40 wt. %, or less than about 35 wt. %, or less than about 31 wt. % of the pork rind and/or cow hide component. In an example, the at least one extruded layer or at least two extruded layers and/or at least one extrusion composition, and/or the extruded composition, comprises about 30 wt. % pork rind component. Examples of pork rind components include products with the tradename: Drinde B95 SF or Drinde 1015/SF.

In an embodiment, the pork rind and/or cow hide component may be in the form of a powder. The pork rind and/or cow hide component powder may have any suitable particle size. The pork rind or cow hide component powder may have a d₅₀ particle size from about 0.1 mm to about 1 mm, or preferably from about 0.1 mm to about 0.5 mm, or from about 0.1 to 0.35 mm.

### Soybean Protein

In an embodiment, the at least one extruded layer or at least two extruded layers and/or at least one extrusion composition, and/or the extruded composition, comprises soybean protein in any suitable amount. In an embodiment, the at least one extruded layer or at least two extruded layers and/or at least one extrusion composition, and/or the extruded composition, comprises from about 2 wt. % to about 25 wt. %, or from about 2.5 wt. % to about 20 wt. %, or from about 3 wt. % to about 15 wt. %, preferably from about 4 wt. % to about 13 wt. %, more preferably in an amount from about 7 wt. % to about 11 wt %, or even more preferably from about 8 wt. % to about 10.5 wt. % soybean protein. In an embodiment, the at least one extruded layer or at least two extruded layers and/or at least one extrusion composition, and/or the extruded composition, comprises greater than about 1 wt. %, or greater than about 2 wt. %, or greater than about 3 wt. %, or greater than about 4 wt. %, or greater than about 5 wt. %, or greater than about 6 wt. % soybean protein. In an embodiment, the at least one extruded layer or at least two extruded layers and/or at least one extrusion composition, and/or the extruded composition, comprises less than about 50 wt. %, or less than about 25 wt. %, or less than about 20 wt. %, or less than about 15 wt. %, or less than about 12 wt. % soybean protein.

The at least one extruded layer or at least two extruded layers and/or at least one extrusion composition, and/or the extruded composition, may comprise soybean protein in any form. In a preferred embodiment, the soybean protein is in the form of a powder. Powdered soybean protein may assist with the ease of extrusion.

The soybean powder may have any suitable particle size. In an embodiment, the soybean powder has a d₉₀ from about 0.01 mm to about 0.5 mm, or from about 0.01 mm to about 0.25 mm, or from about 0.01 mm to about 0.15 mm.

In an embodiment, the soybean powder has a d₅₀ particle size of less than about 0.6 mm, or less than about 0.3 mm, or less than about 0.25 mm, and preferably less than about 0.2 mm and even more preferably less than about 0.15 mm. In an embodiment, the soybean powder preferably has a d₉₀ particle size of less than about 0.25 mm, or preferably less than about 0.2 mm, or even more preferably less than about 0.15 mm.

The soybean protein may derive from any source. In an embodiment, the soybean protein is a soybean protein concentrate. In a preferred embodiment, the soybean protein derives from soybean meal, preferably wherein the soybean meal is a defatted soybean meal. The defatted soybean meal may have any suitable soy bean protein content. The defatted soybean meal may have a protein content of from about 30 wt. % to about 55 wt. %, or from about 33 wt. % to about 51 wt. % or from about 36 wt. % to about 48 wt. %. The defatted soybean meal may have a protein content of greater than about 25 wt. %, or greater than about 30 wt. %, or greater than about 33 wt. %, or greater than about 36 wt. %. The defatted soybean meal may have a protein content of less than about 65 wt. %, or less than about 60 wt. %, or less than about 55 wt. %, or less than about 51 wt. %, or less than about 48 wt. %.

The at least one extruded layer or at least two extruded layers and/or at least one extrusion composition, and/or the extruded composition, may comprise defatted soybean meal in any suitable amount. In an embodiment, the at least one extruded layer or at least two extruded layers and/or at least one extrusion composition, and/or the extruded composition, may comprise from about 5 wt. % to about 50 wt. %, preferably from about 13 wt. % to about 26 wt. %, or more preferably from about 18 wt. % to about 25 wt. %, or even more preferably from about 20 wt. % to about 24 wt. % defatted soybean meal. In an embodiment, the at least one extruded layer or at least two extruded layers and/or at least one extrusion composition, and/or the extruded composition, may comprise greater than about 5 wt. %, greater than about 10 wt. %, greater than about 15 wt. %, greater than about 20 wt. % defatted soybean meal. In an embodiment, the at least one extruded layer or at least two extruded layers and/or at least one extrusion composition, and/or the extruded composition, may comprise less than about 50 wt. %, or less than about 40 wt. %, or less than about 30 wt. %, or less than about 25 wt. % defatted soybean meal.

In some examples, the soybean protein is responsible for the composition having a high instantaneous retarded springiness and good malleability. The soybean protein has emulsifying properties and is believed to be important for: (i) binding the fat in the composition; (iii) controlling the water activity; and (iii) supporting the collagen component of the animal skin protein (the collagen triple helix is covered in hydrophobic regions which is thought to integrate more efficiently with the surrounding matrix in the presence of an emulsifying agent). This results in a product with good overall homogeneity that remains desirably tough. The controlled water activity results in a product that is safe from a microbiological perspective. The edible animal chew also has a good surface finish.

### Potato Protein

Potato protein was found to function in a similar way to soybean protein. It can be useful to use in a composition, where there is a desire to remove certain ingredients and/or produce the composition free from grain legumes.

In an embodiment, the at least one extruded layer or at least two extruded layers and/or at least one extrusion composition, and/or the extruded composition, comprises potato protein in any suitable amount. In an embodiment, the at least one extruded layer or at least two extruded layers and/or at least one extrusion composition, and/or the extruded composition, comprises from about 2 wt. % to about 40 wt. %, or from about 5 wt. % to about 35 wt. %, or from about 10 wt. % to about 30 wt. %, preferably from about 10 wt. % to about 30 wt. %, more preferably in an amount from about 15 wt. % to about 28 wt %, or even more preferably from about 20 wt. % to about 25 wt. % potato protein. In an embodiment, the at least one extruded layer or at least two extruded layers and/or at least one extrusion composition, and/or the extruded composition, comprises greater than about 1 wt. %, or greater than about 5 wt. %, or greater than about 10 wt. %, or greater than about 15 wt. %, or greater than about 20 wt potato protein. In an embodiment, the at least one extruded layer or at least two extruded layers and/or at least one extrusion composition, and/or the extruded composition, comprises less than about 50 wt. %, or less than about 40 wt. %, or less than about 35 wt. %, or less than about 30 wt. %, or less than about 25 wt. % potato protein.

The at least one extruded layer or at least two extruded layers and/or at least one extrusion composition, and/or the extruded composition, may comprise potato protein in any form. In a preferred embodiment, the soybean protein is in the form of a powder. Powdered protein protein may assist with the ease of extrusion. The potato protein is preferably in the form of an isolate from potato, which may be a substance extracted from potato, optionally in powdered form, and/or containing at least 50 wt % protein, optionally at least 70 wt % protein, optionally at least 77 wt % protein.

The protein powder may have any suitable particle size. In an embodiment, the protein powder has a d₉₀ from about 0.01 mm to about 0.5 mm, or from about 0.01 mm to about 0.25 mm, or from about 0.01 mm to about 0.15 mm.

In an embodiment, the protein powder has a d₅₀ particle size of less than about 0.6 mm, or less than about 0.3 mm, or less than about 0.25 mm, and preferably less than about 0.2 mm and even more preferably less than about 0.15 mm. In an embodiment, the potato protein powder preferably has a d₉₀ particle size of less than about 0.25 mm, or preferably less than about 0.2 mm, or even more preferably less than about 0.15 mm.

The potato protein may derive from any source. In an embodiment, the potato protein is a potato protein concentrate.

In some examples, the potato protein is responsible for the composition having a high instantaneous retarded springiness and good malleability. The potato protein has been found to have emulsifying properties and is believed to be important for: (i) binding the fat in the composition; (iii) controlling the water activity; and (iii) supporting the collagen component of the animal skin protein (the collagen triple helix is covered in hydrophobic regions which is thought to integrate more efficiently with the surrounding matrix in the presence of an emulsifying agent). This results in a product with good overall homogeneity that remains desirably tough. The controlled water activity results in a product that is safe from a microbiological perspective. The edible animal chew also has a good surface finish.

### Starch

In an embodiment, the at least one extruded layer or at least two extruded layers and/or at least one extrusion composition, and/or the extruded composition, may further comprise a starch. The starch may be an unmodified starch or a modified starch. The starch may be derived from corn, wheat, modified wheat, tapioca, sorghum, potato, sweet potato, rice, oats, beets, barley, soy, other cereals or grains or a combination thereof. The starch may comprise one type of starch or may comprise a mixture of starches. Pure or substantially pure starches may be used if desired. The type(s) of starch(es) used may be characterised by starch profiles having all possible proportions of amylopectin, intermediates and amylose. The exact source(s) of starch used may not be critical. The starch source(s) may be selected on the basis of cost and palatability considerations.

In a preferred embodiment, the starch may comprise a native potato starch or a waxy starch. These starches, when included in an edible animal chew, may produce an animal chew with higher strength characteristics compared to other starches. The waxy starch is preferably a waxy maize starch, but waxy starches from other species may be used. The waxy starch may be native or modified. Modified waxy starches may be modified by acetylation, hydroxypropylation or by enzymatic treatment. In a preferred embodiment, the starch is selected from native potato starch, a native waxy maize starch, an acetylated waxy maize starch (e.g. acetylated distarch adipate), a hydroxypropylated waxy maize starch, an enzyme treated waxy maize starch, a waxy starch from any other species, or a combination thereof. In some examples, the starch is potato starch. In some examples, the starch is native potato starch. In some examples, the at least one extruded layer or at least two extruded layers and/or at least one extrusion composition, and/or the extruded composition comprise potato starch and the plant protein comprises or is potato protein. In other examples, the starch is an acetylated waxy maize starch.

In some embodiments, the at least one extruded layer or at least two extruded layers and/or at least one extrusion composition, and/or the extruded composition, may comprise from about 5 wt. % to about 50 wt. %, or from about 6 wt. % to about 40 wt. %, or from about 7 wt. % to about 30 wt. %, or from about 8 wt. % to about 25 wt. %, or more preferably from about 9 wt. % to about 20 wt. % and even more preferably from about 10 wt. % to about 15 wt. % starch. In some embodiments, the at least one extruded layer or at least two extruded layers and/or at least one extrusion composition, and/or the extruded composition, may comprise from about 5 wt. % to about 50 wt. %, or from about 6 wt. % to about 40 wt. %, or from about 10 wt. % to about 40 wt. %, or from about 15 wt. % to about 30 wt. %, or more preferably from about 15 wt. % to about 25 wt. % and even more preferably from about 15 wt. % to about 20 wt. % starch, which may be potato starch. In some embodiments, the at least one extruded layer or at least two extruded layers and/or at least one extrusion composition, and/or the extruded composition, may comprise greater than about 6 wt. %, or greater than about 7 wt. %, or greater than about 8 wt. %, or greater than about 9 wt. %, or greater than 10 about wt. %, or greater than about 11 wt. % or greater than about 12 wt. % starch. In some embodiments, the at least one extruded layer or at least two extruded layers and/or at least one extrusion composition, and/or the extruded composition, may comprise less than about 50 wt. %, in an amount less than about 40 wt. %, or less than about 30 wt. %, or less than about 20 wt. %, or less than about 15 wt. % starch. In an example, the at least one extruded layer or at least two extruded layers and/or at least one extrusion composition, and/or the extruded composition, may comprises about 13 wt. % starch. In other examples, the at least one extruded layer or at least two extruded layers and/or at least one extrusion composition, and/or the extruded composition, is substantially free starch, in other words, the at least one extruded layer or at least two extruded layers and/or at least one extrusion composition, and/or the extruded composition, comprises about 0 wt. % starch.

The starch may be in the form of a power. The starch powder may have d₅₀ particle size from about 1 μm to about 250 μm, preferably from about 1 μm to about 200 μm.

Some examples of starch products that may be used include Potato Starch (Native), Waxy Maize Starch, Hydroxypropylated Waxy Maize Starch (e.g. Clearam® CR 15 20 (Roquette) and Acetylated Waxy Maize Starch E1422 (e.g. Clearam® CH 10 20 (Roquette).

In some examples, the starch is added to improve the viscoplastic properties and/or reduce the cost of the extruded layer(s) or extrusion composition(s) or extruded composition(s).

### Alkyl Succinate Modified Starch

In an embodiment, the at least one extruded layer or at least two extruded layers and/or at least one extrusion composition, and/or the extruded composition, may further comprise an alkyl succinate modified starch, which is different to the starch outlined above. The alkyl succinate of the alkyl succinate modified starch may be a C4 to C12 alkyl succinate, or optionally a C5 to C11 alkyl succinate, or optionally a C6 to C10 alkyl succinate, or optionally a C7 to C9 alkyl succinate, preferably, a C8 alkyl succinate.

The succinate of the alkyl succinate modified starch may be a metal succinate. The metal may be selected from Group 1 metals, Group 2 metals and Group 3 metals or a combination thereof. The metal succinate may be selected from sodium succinate, potassium succinate, magnesium succinate, calcium succinate and aluminium succinate or a combination thereof.

Preferably, the alkyl succinate modified starch is selected from sodium octenyl succinate starch, calcium octenyl succinate starch, potassium octenyl succinate starch, aluminium octenyl succinate starch or a combination thereof. Alkyl succinate modified starch is available commercially, e.g. products sold under the trade names Clearam® and Cleargum®, available from Roquette®. In an example, the alkyl succinate modified starch is a sodium octenyl succinate starch.

The modified starch of the alkyl succinate modified starch may be formed by modification of a starch selected from maize starch (optionally waxy maize starch), potato starch (optionally, high viscosity potato starch), tapioca starch or combinations thereof. The alkyl succinate modified starch may be formed by chemical addition of alkyl succinate groups to a hydrolysed dextrin. The alkyl succinate modified starch may be a thin boiling alkyl succinate modified starch, that is, an alkyl succinate modified starch that contributes little viscosity during processing under heat and hydration.

The at least one extruded layer or at least two extruded layers and/or at least one extrusion composition, and/or the extruded composition, may comprise the alkyl succinate modified starch in any suitable amount. In an embodiment, the at least one extruded layer or at least two extruded layers and/or at least one extrusion composition, and/or the extruded composition, may comprise from about 0 wt. % to about 15 wt. %, or from about 0.25 wt. % to about 15 wt. %, or from about 0.5 wt. % to about 15 wt. %, or from about 2 wt. % to about 15 wt. %, or from about 5 wt. % to about 15 wt. %, or from about 10 wt. % to about 15 wt. % alkyl succinate modified starch.

In an embodiment, the at least one extruded layer or at least two extruded layers and/or at least one extrusion composition, and/or the extruded composition, may comprise less than about 13 wt. %, or less than about 11 wt. %, or less than about 8 wt. %, or less than about 6 wt. %, or less than about 4 wt. %, or less than about 2 wt. %, or less than about 0.5%, or less than about 0.25 wt. % alkyl succinate modified starch. In an embodiment, the at least one extruded layer or at least two extruded layers and/or at least one extrusion composition, and/or the extruded composition, may comprise greater than about 0.25% by weight, or greater than about 0.5%, or greater than about 1%, or greater than about 2 wt. %, or greater than about 5 wt. %, or greater than about 8 wt. %, or greater than about 10 wt. %, or greater than about 12 wt. % alkyl succinate modified starch. In some examples, the at least one extruded layer or at least two extruded layers and/or at least one extrusion composition, and/or the extruded composition, is substantially free of alkyl succinate modified starch, in other words, the at least one extruded layer or at least two extruded layers and/or at least one extrusion composition, and/or the extruded composition, comprises about 0 wt. % alkyl succinate modified starch. In some examples, the at least one extruded layer or at least two extruded layers and/or at least one extrusion composition, and/or the extruded composition, comprises about 13 wt. % alkyl succinate modified starch.

The alkyl succinate modified starch may be in the form of a power. The powdered alkyl succinate modified starch may have an average particle size from about 1 μm to about 250 μm, preferably from about 1 μm to about 200 μm.

Some examples of starch products that may be used include E1450, for example Cleargum CO 01 (Roquette®). In some examples, the alkyl succinate modified starch acts as an additional emulsifier. In some examples, the alkyl succinate modified starch can bind the fat in the edible animal chew composition, reducing the disruptive effects of fat on processing. In some examples, the alkyl succinate modified starch allows water (including steam) to disperse evenly within the edible animal chew composition during extrusion.

### Water

The at least one extruded layer or at least two extruded layers and/or at least one extrusion composition, and/or the extruded composition, may further comprise water. In an embodiment, the at least one extruded layer or at least two extruded layers and/or at least one extrusion composition, and/or the extruded composition, comprises from about 3 wt. % to about 30 wt. %, or preferably from 5 wt. % to about 25 wt. %, preferably from about 7 wt. % to about 20 wt. %, even more preferably from about 10 wt. % to about 15 wt. % water. In an embodiment, the at least one extruded layer or at least two extruded layers and/or at least one extrusion composition, and/or the extruded composition, comprises greater than about 5 wt. %, preferably greater than about 6 wt. %, preferably greater than about 7 wt. %, preferably greater than about 8 wt. %, preferably greater than about 9 wt. %, preferably greater than about 10 wt. %, preferably greater than about 11 wt. %, preferably greater than about 12 wt. % water. In an embodiment, the at least one extruded layer or at least two extruded layers and/or at least one extrusion composition, and/or the extruded composition, comprises less than about 25 wt. %, preferably less than about 24 wt. %, preferably less than about 23 wt. %, preferably less than about 22 wt. %, preferably less than about 21 wt. %, preferably less than about 20 wt. %, preferably less than about 19 wt. %, preferably less than about 18 wt. %, preferably less than about 17 wt. %, preferably less than about 16 wt. %, preferably less than about 15 wt. %, preferably less than about 14 wt. % water. In some examples, the at least one extruded layer or at least two extruded layers and/or at least one extrusion composition, and/or the extruded composition, comprises about 13 wt. % water.

In an embodiment, the at least one extruded layer and/or at least one extrusion composition, and/or the extruded composition, further comprises a starch and water as described herein. In an embodiment, the at least one extruded layer and/or at least one extrusion composition, and/or the extruded composition, further comprises a starch, an alkyl succinate modified starch and water as described herein.

### Plasticiser

The at least one extruded layer or at least two extruded layers and/or at least one extrusion composition, and/or the extruded composition, may further comprise a plasticiser. The plasticiser may comprise a polyol, esters of citric acid or urea. Suitable polyols include glycol, diethylene glycol, alkylene glycols, polyalkylene glycol, sorbitol, glycerol, glycerol monoesters or a combination thereof. In an example, the plasticiser is glycerol.

The at least one extruded layer or at least two extruded layers and/or at least one extrusion composition, and/or the extruded composition, may further comprise the plasticiser in any suitable amount. In an embodiment, the at least one extruded layer or at least two extruded layers and/or at least one extrusion composition, and/or the extruded composition, comprises from about 3 wt. % to about 50 wt. %, or from about 5 wt. % to about 45 wt. %, or from about 10 wt. % to about 35 wt. %, or preferably from about 15 wt. % to about 30 wt. %, or even more preferably from about 20 wt. % to about 25 wt. % plasticiser. In an embodiment, the at least one extruded layer or at least two extruded layers and/or at least one extrusion composition, and/or the extruded composition, comprises greater than about 5 wt. %, or greater than about 10 wt. %, or greater than about 15 wt. %, or greater than about 20 wt. % plasticiser. In an embodiment, the at least one extruded layer or at least two extruded layers and/or at least one extrusion composition, and/or the extruded composition, comprises less than about 50 wt. % of the composition, or less than about 45 wt. %, or less than about 40 wt. %, or less than about 35 wt. %, or less than about 30 wt. %, or less than about 25 wt. % plasticiser. In an example, the at least one extruded layer or at least two extruded layers and/or at least one extrusion composition, and/or the extruded composition, comprises about 22 wt. % plasticiser. In an embodiment, the at least one extruded layer or at least two extruded layers and/or at least one extrusion composition, and/or the extruded composition, comprises 20 wt % or less of plasticiser, optionally 15 wt % or less plasticiser, optionally 5 wt % to 20 wt % plasticiser, optionally 5 wt % to 15 wt % plasticiser.

In an embodiment, the at least one extruded layer or at least two extruded layers and/or at least one extrusion composition, and/or the extruded composition, further comprises a starch, a plasticiser and water as described herein. In an embodiment, the at least one extruded layer or at least two extruded layers and/or at least one extrusion composition, and/or the extruded composition, further comprises a starch, an alkyl succinate modified starch, a plasticiser and water as described herein.

### Humectant

In an embodiment, the at least one extruded layer or at least two extruded layers and/or at least one extrusion composition, and/or the extruded composition, may further comprise a humectant. The humectant may comprise sucrose, sodium chloride, sorbitol, glycerol, starch hydrolysate, glucose, maltose, lactose, gums, galactose, citric acid, alanine, glycine, high fructose corn syrup, tartaric acid, malic acid, xylose, PEG 400, PEG 600, propylene glycol, aminobutyric acid, mannitol, mannose, or lactulose. Glycerol and/or glycol may function as both a plasticiser and a humectant. The humectant may be present in any suitable amount.

### Other Additives

In an embodiment, the at least one extruded layer or at least two extruded layers and/or at least one extrusion composition, and/or the extruded composition, may further comprise one or more additives, which may be different to the components listed above (i.e. animal skin protein, protein selected from soy bean protein and potato protein, starch, modified starch alkyl succinate, water, plasticiser or humectant). The one or more further additives may be selected from a preservative, such as potassium sorbate, an anti-oxidant, a pharmaceutical, a nutraceutical, a topical antiseptic, a natural food colorant, a synthetic food colourant, minerals, vitamins or a combination thereof. In an embodiment, the at least one extruded layer or at least two extruded layers and/or at least one extrusion composition, and/or the extruded composition, may comprise less than about 20 wt. %, or less than about 10 wt. %, or less than about 5 wt. %, or less than about 1 wt. % of the one or more additives. In an embodiment, the at least one extruded layer or at least two extruded layers and/or at least one extrusion composition, and/or the extruded composition may comprise preservative, e.g. a sorbate such as potassium sorbate, in an amount of 5 wt % or less, optionally 3 wt % or less, optionally 1 wt % or less, optionally 0.1 to 5 wt %, optionally 0.1 wt % to 3 wt %, optionally 0.1 wt % to 1 wt %, optionally 0.1 wt % to 0.5 wt %.

In an embodiment, the at least one extruded layer or at least two extruded layers and/or at least one extrusion composition, and/or the extruded composition, substantially free of any other animal protein. In an embodiment, the at least one extruded layer or at least two extruded layers and/or at least one extrusion composition, and/or the extruded composition, is substantially free of any other vegetable protein, such as gluten. Extruded products free of gluten may be advantageous since the edible animal chew is suitable for animals that have a gluten intolerance.

### Exemplary Compositions

In an embodiment, the weight ratio of animal skin protein to animal fat in the at least one extruded layer or at least two extruded layers and/or at least one extrusion composition, and/or the extruded composition, is from about 3:1 to about 14:1, preferably from about 4:1 to about 11:1.

In an embodiment, the weight ratio of animal skin protein to plant protein selected from soybean protein and potato protein in the at least one extruded layer or at least two extruded layers and/or at least one extrusion composition, and/or the extruded composition, is from about 1:2 to about 5:1, preferably from about 1:1.5 to about 3.5:1.

In an embodiment, the weight ratio of animal skin protein to potato protein in the at least one extruded layer or at least two extruded layers and/or at least one extrusion composition, and/or the extruded composition, is from about 1:2 to about 3:1, preferably from about 1:1.5 to about 1.5:1, preferably from 1:1 to 1.5:1.

In an embodiment, the at least one extruded layer or at least two extruded layers and/or at least one extrusion composition, and/or the extruded composition, comprise:

animal skin protein, wherein the animal skin is porcine or bovine,
animal fat, wherein the animal fat is porcine or bovine, and
a plant protein selected from soybean protein and potato protein,
and starch,
wherein the animal skin protein and animal fat together constitute at least 10 wt % of the extruded composition, at least 15 wt % of the extruded composition, optionally at least 20 wt % of the extruded composition, optionally from 10 wt % to 50 wt %, optionally from 15 wt % to 40 wt %, optionally from 20 wt % to 40 wt %, optionally from 30 wt % to 40 wt % of the extruded composition;
the plant protein constitutes at least 10 wt % of the extruded composition, optionally at least 15 wt % of the extruded composition, optionally from 10 wt % to 30 wt %, optionally from 15 wt % to 30 wt %, optionally from 20 wt % to 30 wt %, and
the starch constitutes at least 10 wt % of the extruded composition, optionally at least 15 wt % of the extruded composition; optionally from 10 wt % to 30 wt %; optionally from 10 wt % to 25 wt %, optionally from 15 wt % to 20 wt %. The edible animal chew may further comprise a further component selected from water and a plasticiser, such as glycerol; the further component selected from water and a plasticiser, such as glycerol, may constitute at least 90 wt % of the balance of the composition (after the animal skin protein, animal fat, the plant protein, and starch have been accounted for). The plasticiser, if present, may constitute from 1 wt % to 30 wt % of the composition or layer, optionally from 5 wt % to 20 wt % of the composition or layer, optionally from 5 wt % to 15 wt %, optionally from 10 wt % to 15 wt %, optionally from 5 wt % to 10 wt % of the composition or layer.
In an embodiment, the at least one extruded layer or at least two extruded layers and/or at least one extrusion composition, and/or the extruded composition, comprise:
animal skin protein, wherein the animal skin is porcine or bovine,
animal fat, wherein the animal fat is porcine or bovine, and
a plant protein selected from soybean protein and potato protein,
and starch,
wherein the animal skin protein and animal fat together constitute from 10 wt % to 50 wt %, optionally from 15 wt % to 40 wt %, optionally from 20 wt % to 40 wt %, optionally from 30 wt % to 40 wt % of the extruded composition;
the plant protein constitutes from 10 wt % to 30 wt %, optionally from 15 wt % to 30 wt %, optionally from 20 wt % to 30 wt % of the extruded composition and
the starch constitutes from 10 wt % to 30 wt %; optionally from 10 wt % to 25 wt %, optionally from 15 wt % to 20 wt %. The edible animal chew may further comprise a further component selected from water and a plasticiser, such as glycerol; the further component selected from water and a plasticiser, such as glycerol, may constitute (or further components together constitute, if water and plasticiser are both present) at least 90 wt % of the balance of the composition (after the animal skin protein, animal fat, the plant protein, and starch have been accounted for). The plasticiser, if present, may constitute from 1 wt % to 30 wt % of the composition, optionally from 5 wt % to 20 wt % of the composition, optionally from 5 wt % to 15 wt %, optionally from 10 wt % to 15 wt %, optionally from 5 wt % to 10 wt %.
In an embodiment, the at least one extruded layer or at least two extruded layers and/or at least one extrusion composition, and/or the extruded composition, comprise:
animal skin protein, wherein the animal skin is porcine or bovine,
animal fat, wherein the animal fat is porcine or bovine, and
a plant protein selected from soybean protein and potato protein,
and starch,
wherein the animal skin protein and animal fat together constitute from from 20 wt % to 40 wt %, optionally from 25 wt % to 40 wt % of the extruded composition;
the plant protein constitutes from 15 wt % to 30 wt %, optionally from 20 wt % to 30 wt % of the extruded composition and
the starch constitutes from 10 wt % to 30 wt %; optionally from 10 wt % to 25 wt %, optionally from 15 wt % to 20 wt % of the extruded composition. The edible animal chew may further comprise a further component selected from water and a plasticiser, such as glycerol; the further component selected from water and a plasticiser, such as glycerol, may constitute (or further components together constitute, if water and plasticiser are both present) at least 90 wt % of the balance of the composition (after the animal skin protein, animal fat, the plant protein, and starch have been accounted for). The plasticiser, if present, may constitute from 1 wt % to 30 wt % of the composition, optionally from 5 wt % to 20 wt % of the composition, optionally from 5 wt % to 15 wt %, optionally from 10 wt % to 15 wt %, optionally from 5 wt % to 10 wt %.

In an embodiment, the at least one extruded layer or at least two extruded layers and/or at least one extrusion composition, and/or the extruded composition, comprises water and a plasticiser and comprises:

about 7 wt. % to about 47 wt. % animal skin protein; optionally from about 10 wt % to 47 wt % animal skin protein;
about 0.5 wt. % to about 8 wt. % animal fat;
about 4 wt. % to about 35 wt. % plant protein selected from soybean protein and potato protein;
and
about 0 wt. % to about 40 wt.;% starch, optionally from about 8 wt. % to about 25 .wt % starch,
about 5 wt. % to about 25 wt. % water, and optionally,
about 5 wt. % to about 45 wt. % plasticiser, optionally from 5 wt % to 30 wt % plasticiser, optionally from 5 wt % to 20 wt % plasticiser, optionally from 5 wt % to 15 wt % plasticiser, optionally from 10 wt % to 15 wt % plasticiser, optionally from 5 wt % to 10 wt % plasticiser.

In an embodiment, the at least one extruded layer or at least two extruded layers and/or at least one extrusion composition, and/or the extruded composition, comprises water and a plasticiser and comprises:

about 8 wt. % to about 32 wt. % animal skin protein; optionally from about 10 wt. % to about 32 wt. % animal skin protein
about 1 wt. % to about 5 wt. % animal fat;
about 7 wt. % to about 11 wt. % plant protein selected from soybean protein and potato protein;
about 0 wt. % to about 40 wt. % starch, optionally from about 8 wt. % to about 25 .wt % starch,
about 5 wt. % to about 25 wt. % water, and
about 5 wt. % to about 45 wt. % plasticiser, optionally from 5 wt % to 15 wt % plasticiser, optionally from 10 wt % to 15 wt % plasticiser, optionally from 5 wt % to 10 wt % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 8 wt. % to about 10.5 wt. % plant protein selected from soybean protein and potato protein;
about 0 wt. % to about 40 wt. % starch, optionally from about 10 wt. % to about 15 .wt % starch,
about 5 wt. % to about 25 wt. % water, and about 5 wt. % to about 45 wt. % plasticiser, optionally from 5 wt % to 15 wt % plasticiser, optionally from 10 wt % to 15 wt % plasticiser, optionally from 5 wt % to 10 wt % plasticiser.

In an embodiment, the animal skin protein and the animal fat derive from a pork skin or cow hide component and (if present) the soybean protein derives from soybean meal, and wherein the at least one extruded layer or at least two extruded layers and/or at least one extrusion composition, and/or the extruded composition, comprises:

about 13 wt. % to about 52 .wt % pork skin or cow hide component,
about 13 wt. % to about 26.% of a component selected from soybean meal and potato protein,
and
about 0 wt. % to about 40 wt. % starch, optionally from about 8 wt. % to about 25 .wt % starch,
about 5 wt. % to about 25 wt. % water, and
about 5 wt. % to about 45 wt. % plasticiser, optionally from 5 wt % to 15 wt % plasticiser, optionally from 10 wt % to 15 wt % plasticiser, optionally from 5 wt % to 10 wt % plasticiser.

In an embodiment, the animal skin protein and the animal fat derive from a pork skin or cow hide component and (if present) the soybean protein derives from soybean meal, and wherein the at least one extruded layer or at least two extruded layers and/or at least one extrusion composition, and/or the extruded composition, comprises:

about 13 wt. % to about 52 .wt % pork skin or cow hide component,
about 13 wt. % to about 26.% a component selected from soybean meal and potato protein,
about 0 wt. % to about 40 wt. % starch, optionally from about 8 wt. % to about 25 .wt % starch,
about 5 wt. % to about 25 wt. % water, and
about 5 wt. % to about 45 wt. % plasticiser.

In an embodiment, the weight ratio of animal skin protein to animal fat in the at least one extruded layer or at least two extruded layers and/or at least one extrusion composition, and/or the extruded composition, is from about 3:1 to about 14:1, preferably from about 4:1 to about 11:1.

In an embodiment, the weight ratio of animal skin protein to soybean protein in the at least one extruded layer or at least two extruded layers and/or at least one extrusion composition, and/or the extruded composition, is from about 1.4:1 to about 5:1, preferably from about 1.7:1 to about 3.5:1.

In an embodiment, the at least one extruded layer or at least two extruded layers and/or at least one extrusion composition, and/or the extruded composition, comprises water and a plasticiser and comprises:

about 7 wt. % to about 47 wt. % animal skin protein;
about 0.5 wt. % to about 8 wt. % animal fat;
about 4 wt. % to about 13 wt. % soybean protein; and
about 0 wt. % to about 40 wt. % starch, optionally from about 8 wt. % to about 25 .wt % starch,
about 5 wt. % to about 25 wt. % water, and optionally,
about 5 wt. % to about 45 wt. % plasticiser.

In an embodiment, the at least one extruded layer or at least two extruded layers and/or at least one extrusion composition, and/or the extruded composition, comprises water and a plasticiser and comprises:

about 8 wt. % to about 32 wt. % animal skin protein;
about 1 wt. % to about 5 wt. % animal fat;
about 7 wt. % to about 11 wt. % soybean protein;
about 0 wt. % to about 40 wt. % starch, optionally from about 8 wt. % to about 25 .wt % starch,
about 5 wt. % to about 25 wt. % water, and
about 5 wt. % to about 45 wt. % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 8 wt. % to about 10.5 wt. % soybean protein;
about 0 wt. % to about 40 wt. % starch, optionally from about 10 wt. % to about 15 .wt % starch,
about 5 wt. % to about 25 wt. % water, and
about 5 wt. % to about 45 wt. % plasticiser.

In an embodiment, the animal skin protein and the animal fat derive from a pork skin or cow hide component and the soybean protein derives from soybean meal, and

wherein the at least one extruded layer or at least two extruded layers and/or at least one extrusion composition, and/or the extruded composition, comprises:
about 13 wt. % to about 52 .wt % pork skin or cow hide component,
about 13 wt. % to about 26.% soybean meal, and
about 0 wt. % to about 40 wt. % starch, optionally from about 8 wt. % to about 25 .wt % starch,
about 5 wt. % to about 25 wt. % water, and
about 5 wt. % to about 45 wt. % plasticiser.

In an embodiment, the animal skin protein and the animal fat derive from a pork skin or cow hide component and the soybean protein derives from soybean meal, and

wherein the at least one extruded layer or at least two extruded layers and/or at least one extrusion composition, and/or the extruded composition, comprises:
about 13 wt. % to about 52 .wt % pork skin or cow hide component,
about 13 wt. % to about 26.% soybean meal,
about 0 wt. % to about 40 wt. % starch, optionally from about 8 wt. % to about 25 .wt % starch,
about 5 wt. % to about 25 wt. % water, and
about 5 wt. % to about 45 wt. % plasticiser, optionally 5 wt % to 20 wt % plasticiser, optionally 5 wt % to 15 wt % plasticiser.

In an embodiment, the at least one extruded layer or at least two extruded layers and/or at least one extrusion composition, and/or the extruded composition, comprises water and a plasticiser and comprises:

about 7 wt. % to about 47 wt. % animal skin protein;
about 0.5 wt. % to about 8 wt. % animal fat;
about 13 wt. % to about 35 wt. % soybean protein; and
about 0 wt. % to about 40 wt.;% starch, optionally from about 8 wt. % to about 25 .wt % starch,
about 5 wt. % to about 25 wt. % water, and optionally,
plasticiser in an amount of less than 20 wt %, optionally 5 wt % to 20 wt % plasticiser, optionally 5 wt % to 15 wt % plasticiser.

In an embodiment, the at least one extruded layer or at least two extruded layers and/or at least one extrusion composition, and/or the extruded composition, comprises water and a plasticiser and comprises:

about 8 wt. % to about 32 wt. % animal skin protein;
about 1 wt. % to about 5 wt. % animal fat;
about 20 wt. % to about 30 wt. % soybean protein;
about 0 wt. % to about 40 wt. % starch, optionally from about 8 wt. % to about 25 .wt % starch,
about 5 wt. % to about 25 wt. % water, and
plasticiser in an amount of less than 20 wt %, optionally 5 wt % to 20 wt % plasticiser, optionally 5 wt % to 15 wt % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 20 wt. % to about 30 wt. % soybean protein;
about 0 wt. % to about 40 wt. % starch, optionally from about 10 wt. % to about 20 wt % starch,
about 5 wt. % to about 25 wt. % water, and
plasticiser in an amount of less than 20 wt %, optionally 5 wt % to 20 wt % plasticiser, optionally 5 wt % to 15 wt % plasticiser.

In an embodiment, the animal skin protein and the animal fat derive from a pork skin or cow hide component and the soybean protein derives from soybean meal, and wherein the at least one extruded layer or at least two extruded layers and/or at least one extrusion composition, and/or the extruded composition, comprises:

about 25 wt. % to about 40 .wt % pork skin or cow hide component,
about 13 wt. % to about 26.% soybean meal,
about 10 wt. % to about 40 wt. % starch, optionally from about 10 wt. % to about 25 .wt % starch,
about 5 wt. % to about 25 wt. % water, and
plasticiser in an amount of less than 20 wt %, optionally 5 wt % to 20 wt % plasticiser, optionally 5 wt % to 15 wt % plasticiser.

In an embodiment, the animal skin protein and the animal fat derive from a pork skin or cow hide component and the soybean protein derives from soybean meal, and

wherein the at least one extruded layer or at least two extruded layers and/or at least one extrusion composition, and/or the extruded composition, comprises:
about 25 wt. % to about 40 .wt % pork skin or cow hide component,
about 13 wt. % to about 26.% soybean meal,
about 10 wt. % to about 25 .wt % starch,
about 5 wt. % to about 25 wt. % water, and
plasticiser in an amount of less than 20 wt %, optionally 5 wt % to 20 wt % plasticiser, optionally 5 wt % to 15 wt % plasticiser.

In an embodiment, the at least one extruded layer or at least two extruded layers and/or at least one extrusion composition, and/or the extruded composition, comprises water and a plasticiser and comprises:

about 7 wt. % to about 47 wt. % animal skin protein;
about 0.5 wt. % to about 8 wt. % animal fat;
about 15 wt. % to about 28 wt. % potato protein; and
about 0 wt. % to about 40 wt. % starch, which may comprise or be potato starch, optionally from
about 8 wt. % to about 25 .wt % starch, which may comprise or be potato starch,
about 5 wt. % to about 25 wt. % water, and optionally, about 5 wt. % to about 45 wt. % plasticiser.

In an embodiment, the at least one extruded layer or at least two extruded layers and/or at least one extrusion composition, and/or the extruded composition, comprises water and a plasticiser and comprises:

about 8 wt. % to about 32 wt. % animal skin protein;
about 1 wt. % to about 5 wt. % animal fat;
about 15 wt. % to about 28 wt. % potato protein;
about 0 wt. % to about 40 wt. % starch, which may comprise or be potato starch, optionally from
about 8 wt. % to about 25 .wt % starch, which may comprise or be potato starch,
about 5 wt. % to about 25 wt. % water, and
about 5 wt. % to about 45 wt. % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 20 wt. % to about 25 wt. % potato protein, optionally 22 wt % to 24 wt % potato protein;
about 0 wt. % to about 40 wt. % starch, which may comprise or be potato starch, optionally from
about 10 wt. % to about 25 .wt % starch, which may comprise or be potato starch,
about 5 wt. % to about 25 wt. % water, and
about 5 wt. % to about 45 wt. % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 20 wt. % to about 25 wt. % potato protein, optionally 22 wt % to 24 wt % potato protein;
about 15 wt. % to about 30 wt. % starch, which may comprise or be potato starch, optionally from about 10 wt. % to about 20 .wt % starch, which may comprise or be potato starch optionally from about 15 wt. % to about 20 .wt % starch, which may comprise or be potato starch
about 5 wt. % to about 25 wt. % water, and
about 5 wt. % to about 25 wt. % plasticiser.

In an embodiment, the at least one extruded layer or at least two extruded layers and/or at least one extrusion composition, and/or the extruded composition, comprises:

about 18 wt. % to about 27 wt. % animal skin protein;
about 2 wt. % to about 4.5 wt. % animal fat;
about 20 wt. % to about 25 wt. % potato protein, optionally 22 wt. % to 24 wt. % potato protein;
about 15 wt. % to about 30 wt. % starch, which may comprise or be potato starch, optionally from about 10 wt. % to about 20 .wt % starch, which may comprise or be potato starch, optionally from about 15 wt. % to about 20 .wt % starch, which may comprise or be potato starch,
about 5 wt. % to about 25 wt. % water, and
about 5 wt. % to about 25 wt. % plasticiser.

In an embodiment, the animal skin protein and the animal fat derive from a pork skin or cow hide component and

wherein the at least one extruded layer or at least two extruded layers and/or at least one extrusion composition, and/or the extruded composition, comprises:
about 13 wt. % to about 52 .wt. % pork skin or cow hide component,
about 13 wt. % to about 28.% potato protein, and
about 0 wt. % to about 40 wt. % starch, which may comprise or be potato starch, optionally from about 8 wt. % to about 30 wt % starch, which may comprise or be potato starch, optionally about 15 wt. % to about 25 wt. % starch, which may comprise or be potato starch, optionally from about 10 wt. % to about 20 wt % starch, which may comprise or be potato starch, optionally from about 15 wt % to 20 wt % starch which may comprise or be potato starch;
about 5 wt. % to about 25 wt. % water, and
about 5 wt. % to about 45 wt. % plasticiser.

In an embodiment, the animal skin protein and the animal fat derive from a pork skin or cow hide component, and

wherein the at least one extruded layer or at least two extruded layers and/or at least one extrusion composition, and/or the extruded composition, comprises:
about 13 wt. % to about 52 .wt % pork skin or cow hide component,
about 15 wt. % to about 28.% potato protein, optionally about 20 wt. % to about 25 wt. % potato protein, optionally 22 wt % to 24 wt % potato protein;
about 0 wt. % to about 40 wt. % starch, which may comprise or be potato starch, optionally from about 8 wt. % to about 30 .wt % starch, which may comprise or be potato starch, optionally about 15 wt. % to about 25 wt. % starch, which may comprise or be potato starch, optionally from about 10 wt. % to about 20 wt % starch, which may comprise or be potato starch, optionally from about 15 wt % to 20 wt % starch, which may comprise or be potato starch,
about 5 wt. % to about 25 wt. % water, and
about 5 wt. % to about 45 wt. % plasticiser.

In an embodiment, the animal skin protein and the animal fat derive from a pork skin or cow hide component, and

wherein the at least one extruded layer or at least two extruded layers and/or at least one extrusion composition, and/or the extruded composition, comprises:
about 25 wt. % to about 40 wt. % pork skin or cow hide component,
about 20 wt. % to about 25 wt. % potato protein, optionally 22 wt % to 24 wt % potato protein;
about 10 wt. % to about 20 wt % starch, which may comprise or be potato starch, optionally from about 15 wt % to 20 wt % starch which may comprise or be potato starch,
about 5 wt. % to about 25 wt. % water, and
about 5 wt. % to about 45 wt. % plasticiser.

The plasticiser in any of the above-mentioned compositions may be as described herein, e.g. a polyol, e.g. glycerine. In the compositions above, the animal skin protein and the animal fat is as defined herein.

### Properties of the Edible Animal Chew

In some examples, the edible animal chew has a water activity of from about 0.40 to about 0.85, or from about 0.50 to about 0.85, or from about 0.50 to about 0.80, and more preferably from about 0.50 to about 0.75, and even more preferably from about 0.50 to about 0.70. In some examples, the edible animal chew has a water activity less than about 0.85, or less than about 0.80, or less than about 0.75, or less than about 0.70. The lower the water activity, the less bacteria that can proliferate. The majority of bacterial strains cannot proliferate in edible foods that have a water activity of less than 0.85, and an even larger number of bacterial strains cannot proliferate in edible foods that have a water activity less than 0.70.

In some examples, the edible animal chew has a tensile toughness that is greater than 100 MPa, or greater than 125 MPa, or greater than 150 MPa, or greater than 175 MPa, or preferably greater than 200 MPa, or preferably greater than 225 MPa, or more preferably greater than 250 MPa, or even more preferably greater than 300 MPa. Tensile toughness may be assessed using textural profile analysis. The greater the tensile toughness, the longer lasting the edible animal chew. In some examples, the edible animal chew has a lasting time of about 12 to 18 minutes when chewed by a dog. In some examples, the edible animal chew has a lasting time of at least 12 minutes, or at least 13 minutes, or at least 14 minutes, or at least 15 minutes, or at least 16 minutes, or at least 17 minutes when chewed by a dog.

In some examples, the edible animal chew has an instantaneous retarded springiness (IRS) of less than 90%, or less than 85%, or less than 80%, or less than 75%, or less than 70%. The IRS may be determined using textural profile analysis, for example, using the following formula

$$I R S ( \% ) = \frac{L 1}{L 2} \times 100$$

wherein L1 corresponds to the period in which a force is measured in the downward direction during the first compression cycle and L2 corresponds to the period in which a force is measured in the upward direction during the first compression cycle. Instantaneous retarded springiness (IRS) correlates with the malleability of a material. Malleable materials correlate with materials that can be easily extruded, post-formed and stylised.

The edible animal chew may be formed by any suitable process. In an embodiment, the edible animal chew is produced according to the process described herein.

The edible animal chew may be formed using any suitable apparatus. The edible animal chew may be formed using the nozzle and extrusion apparatus described herein.

### Process

In a second aspect, there is provided a process for producing an edible animal chew comprising at least two extruded layers comprising:
extruding at least one extrusion composition comprising animal skin protein, animal fat and soybean protein to form at least two extruded layers, and
injecting a gas between the at least two extruded layers to form a gap between at least a portion of the at least two extruded layers,
   wherein the animal skin is porcine or bovine and wherein the animal fat is porcine or bovine.

The processes described herein are carried out in an extrusion apparatus. The extrusion apparatus may comprise a barrel and nozzle. The process and extrusion steps described herein may use the nozzle, barrel and/or extrusion apparatus as described herein.

The extruding step may comprise:

feeding the at least one extrusion composition into an extrusion apparatus, for example, in a feeding hopper,
conveying the at least one extrusion composition through the extrusion apparatus, for example, through a barrel and a nozzle.

The barrel comprises at least one hollow chamber at least one screw. The at least one extrusion composition may be extruded using a single screw or a twin screw. The screw may rotate at a speed of from 50 rpm to 400 rpm, optionally a speed of from 80 rpm to 250 rpm, optionally a speed of from 120 rpm to 220 rpm, optionally a speed of from 140 rpm to 200 rpm.

In some embodiments, there is one extrusion composition. For these processes, the extrusion apparatus may comprise a barrel with a single hollow chamber. This may be used to form an edible animal chew wherein the at least two extruded layers are formed of the same material and/or composition, for example, wherein the at least two extruded layers comprise animal skin protein, animal fat and soybean protein in the same proportions.

In other embodiments, there is at least two extrusion compositions, wherein at least one extrusion composition comprises animal skin protein, animal fat and soybean protein, and at least one extrusion composition comprises a different material. For these processes, the barrel may comprise at least two hollow chambers to separately convey the at least two extrusion compositions. The at least two hollow chambers may be connected to two different extrusion channels and/or two different portions of an extrusion channel in the nozzle. This may be used to form an edible animal chew wherein the at least two extruded layers are formed of a different material.

The at least one extrusion composition may be extruded using a specific mechanical energy (SME) from 40 kWhkg⁻¹ to 130 kWhkg⁻¹, optionally from 50 kWhkg⁻¹ to 110 kWhkg⁻¹, optionally from 60 kWhkg⁻¹ to 115 kWhkg⁻¹, optionally from 65 kWhkg⁻¹ to 115 kWhkg⁻¹. The SME may be applied by the barrel.

In some embodiments, the at least one extrusion composition is heated in a heating step. This may occur prior to or during the extrusion step, for example, during the conveying step. The extrusion composition may be heated by the barrel.

In an embodiment, the extrusion composition may be heated to a temperature above the melting point of components of the extrusion composition, for example, above the melting point of animal skin protein, and/or above the melting point of soybean protein. Heating the extrusion composition above the melting point of components in the extrusion composition helps the extrusion composition to flow. In an embodiment, the extrusion composition is heated to a temperature of at least 50° C., optionally of at least 60° C., optionally of at least 70° C., optionally at least 80° C., optionally at least 90° C., or at least 95° C., or at least 100° C., or at least 110° C., or at least 120° C., or at least 130° C.

The gas that is injected may be any suitable gas. In an embodiment, the gas may be selected from compressed air, steam, carbon dioxide or nitrogen. In an example, the gas is compressed air.

In a preferred embodiment, the gas is injected such that an air-gap formed between at least a portion of the at least two extruded layers. This serves to separate the at least two extruded layers. The present inventors found that when air was not injected, a vacuum effect caused the extruded layers to seal together, and the resultant edible animal chews had poor aesthetic appearance.

The gas may be injected at any suitable pressure. In an embodiment, the gas is injected at a pressure from about 0.05 bar to about 4 bar, or from about 0.1 bar to about 3 bar, or from about 0.3 bar to 1.5 bar, preferably from about 0.1 bar to about 1.2 bar. In some examples, the gas is injected at a pressure from about 0.1 bar to 0.4 bar. In some examples, the gas is injected at a pressure from about 0.5 bar to about 3 bar. In some embodiments, the gas is injected in pulses, in other words, the gas is injected intermittently. In other embodiments, the gas is injected at a continuous pressure.

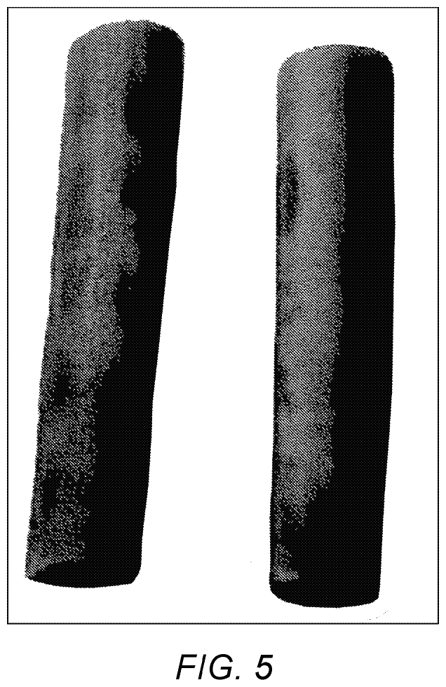

Altering the pressure of gas injected between the at least two extruded layers can be used to generate edible animal chews with different patterns. The size of the air-gap may vary depending on the amount of gas injected. The colour of the edible animal chew may have a different colour or appearance depending on the size or presence of an air-gap. In certain examples, the edible animal chew has a lighter tone or appearance in portions of the edible animal chew with an air-gap between the at least two extruded layers. In some embodiments, the gas is injected at a pressure from about 0.5 to about 3 bar. In some examples, this may cause at least a part of an extruded layer to stretch and become thinner and/or lighter in tone. In some examples, this may be used to give longitudinal stylizing, e.g. In other examples, e.g., with a nozzle comprising concentric cylinders, the outer extruded layer is stretched, which then collapse back onto the inner extruded layer to form a wrinkled pattern (see FIG. 4); this may be used to form an edible animal chew with an appearance of natural hide.

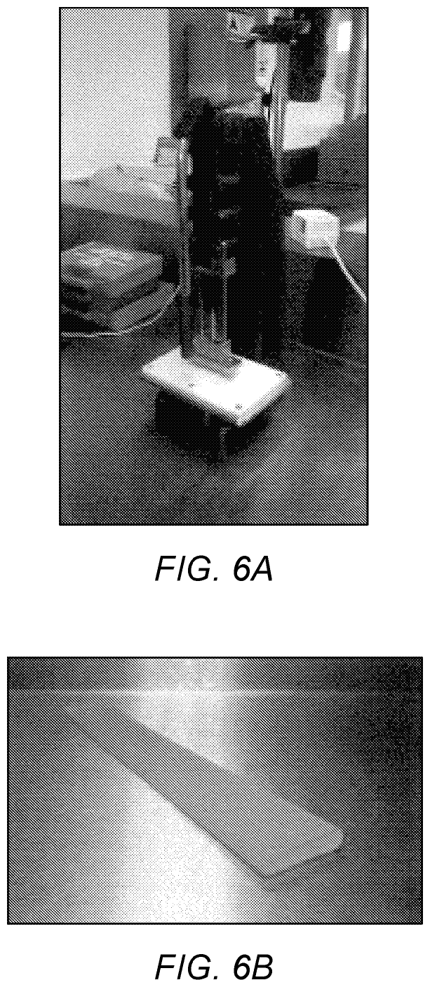

In some embodiments, e.g., with a nozzle comprising concentric cylinders, the gas is injected at a pressure from about 0.1 to 0.4 bar. This may give rise to a mottled pattern (see FIG. 5), which may have an appearance similar to a mottled leather belt.

In a preferred embodiment, the gas is injected as the at least one extrusion composition exits the extrusion apparatus (e.g. exits the nozzle). In an alternative embodiment, the gas is injected into the extrusion composition before the extrusion composition leaves the nozzle.

In some embodiments, prior to the extruding step, there is a mixing step wherein components of the extrusion composition are mixed. The mixing step may involve mixing animal skin protein, animal fat and soybean protein, and optionally starch, optionally water, optionally a plasticiser, and optionally any further additives.

In some embodiments, there is a rolling step after the injecting step, wherein the at least two extruded layers are compressed by a rolling assembly. In some embodiments, the rolling step occurs immediately after the injecting step. In some embodiments, the rolling step may be used to assist the formation of an edible animal chew with a wrinkled pattern (see FIG. 4). After injecting gas at a pressure from about 0.5 to about 3 bar large amounts of air pressure are present between the at least two extruded layers. In some embodiments, the rolling step may be used to push the outer extruded layer firmly back onto the inner extruded layer

In some embodiments, there is no immediate rolling step. The at least two extruded layers may collapse onto one another, for example, to form an edible animal chew with a mottled pattern (see FIG. 5).

In some embodiments, after the injecting step and the optional rolling step, there is a cutting step wherein the extruded layers are cut to a desired length. The extruded layers may be cut with a knife cutter.

### Apparatus

Herein is also provided a nozzle for an extrusion process, comprising

at least one extrusion channel that is configured to form at least two extruded layers
and at least one gas outlet configured to inject gas between the at least two extruded layers.

The nozzle may be used as part of any extrusion apparatus, and may be detachable from the rest of the extrusion apparatus.

The nozzle may have any suitable shape, but in some examples, has a cylindrical shape. The nozzle may have a proximal end configured to be attached to other parts of the extrusion apparatus (e.g. the barrel) and a distal end, which is the end in which the extrusion composition leaves the nozzle. The extrusion channels may span the length of the nozzle, or part of the length of the nozzle starting from the distal end. The nozzle may have a length of about 4 cm to about 30 cm or preferably from about 10 cm to about 18 cm. The nozzle may have a cross-sectional width (or diameter) of 2 cm to about 12 cm or preferably from about 3.5 cm to about 6 cm in its longest direction (for single lane extrusion).

The nozzle herein is configured to produce an edible animal chew with at least two extruded layers with an air-gap between at least a portion of the at least two extruded layers. The extrusion channel(s) may have any suitable cross-sectional shape, which may be regular or irregular. The shape of the extrusion channel(s) determines the cross-sectional shape of the at least two extruded layers. The cross-sectional shape of the extrusion channel(s) may be selected from a circle, an oval, a rounded shape, an n-sided shape, optionally wherein n is selected from 3 to 12, optionally 4, 5, 6, 7, 8, 9, 10 or 11. The cross-sectional shape may be selected from, but not limited to, a triangle, a square, a rectangle, a hexagon, a heptagon, an octagon, or a star.

The nozzle may comprise at least two extrusion channels, or at least three, four, five, six, seven, eight, nine, or at least ten extrusion channels. The at least three, four, five, six, seven, eight, nine, or ten extrusion channels may be used to form the at least three, four, five, six, seven, eight, nine or at least ten extruded layers respectively. In other embodiments, the nozzle may comprise a single extrusion channel with a curved shape, configured to form at least two extruded layers (e.g. an extrusion channel with a zigzag cross-sectional shape). The extrusion channel(s) may have any suitable size or cross-sectional area.

In a preferred embodiment, the at least one extrusion channel comprises at least a first and a second portion. In some embodiments, the at least first and second portions belong to at least two different extrusion channels (in other words, the first portion is a first extrusion channel, and the second portion is a second extrusion channel). In other embodiments, the first and second portion belong to the same extrusion channel. The first portion forms a first extruded layer, and the second portion forms the second extruded layer.

In some embodiments, the at least one extrusion channel may comprise at least three, at least four, at least five, at least six, at least seven, at least eight, at least nine, or at least ten portions. The at least third and fourth portions, and so on, form at least three or at least four extruded layers.

In an embodiment, the first portion has a smaller cross-sectional area than the second portion. During extrusion, this causes the pressure of the first extruded layer to be larger than the second extruded layer. This may cause the second extruded layer to slow or bunch after leaving the nozzle, causing some of the second extruded layer to come into contact with the first extruded layer. In some examples, this leads to an edible animal chew with a regular striped pattern.

In a preferred embodiment, the at least first and second portion are concentrically disposed. The first portion may be an outer concentric extrusion channel and the second portion may be an inner concentric extrusion channel. In an example, the inner and outer concentric extrusion channels are circular (i.e. have a circular cross-sectional shape).

The inner concentric extrusion channel may have an average cross-sectional width in its longest dimension (or diameter for a circular concentric extrusion channel) from about 15 mm to about 35 mm, or more preferably from about 22 mm to about 30 mm. The outer concentric extrusion channel may have an average cross-sectional width in its longest dimension (or diameter for a circular concentric extrusion channel) from about 2 mm to about 1 cm, or more preferably from about 3 mm to about 7 mm.

The inner concentric extrusion channel may have an average thickness from about from about 2 mm to about 10 mm, or more preferably from about 3 mm to about 7 mm. The outer concentric extrusion channel may have an average thickness from about 2 mm to about 10 mm, or more preferably from about 3 mm to about 7 mm. The inner concentric extrusion channel may have a cross-sectional area of from about 50 mm³ to about 1000 mm³, preferably from about 300 mm³ to about 450 mm³. The outer concentric extrusion channel may have a cross-sectional area of from about 50 mm³ to about 1000 mm³, or preferably from about 350 mm³ to about 500 mm³.

In some embodiments, the outer concentric extrusion channel has a smaller cross-sectional area and/or thickness than the inner concentric extrusion channel. The offset between the width of the inner and outer extrusion channels may cause the material of the inner to flow more rapidly. The outer extruded layer may therefore fold and ripple to create a “zigzag” on the inside. Where the “zigzag” touches the outer layer it affects the material to the extent that a darker tone is observed outwardly. This may lead to an edible animal chew with a regular striped pattern as shown in FIG. 3.

The nozzle comprises at least one gas outlet but may comprise at least two, at least three, at least four, at least five, at least six, at least seven, at least eight, at least nine, at least ten, or any number of gas outlets. In a preferred embodiment, the at least one gas outlet is disposed between the at least a first and second portion of the at least one extrusion channel. If the nozzle comprises at least two gas outlets, the gas outlets may be equally spaced between the at least a first and second portion of the at least one extrusion channel.

The gas outlets may have any suitable size. In some embodiments, the gas outlets have a longest dimension of from about 0.2 mm to about 40 mm, more preferably from about 1 mm to about 20 mm, or more preferably from about 2 mm to about 8 mm; and/or a shortest dimension of from 0.2 mm to 10 mm, more preferably from 1.5 mm to 3.5 mm. In some embodiments, the gas outlets may have any suitable shape, wherein the shape may be regular or irregular.

In some embodiments, the gas outlets have a circular shape. The circular gas outlets may have a diameter of from about 0.2 mm to about 10 mm, preferably from about 1 mm to about 5 mm, more preferably from about 2 mm to about 4 mm, for example, about 3 mm.

In some embodiments, the gas outlets may have a crescent shape, which may have a longest dimension of from about 0.2 mm to 40 mm, more preferably from 5 mm to 20 mm, and/or a shortest dimension of 0.1 mm to 10 mm, more preferably from 1.5 mm to 3.5 mm

The gas that is injected may be any suitable gas. In an embodiment, the gas may be selected from compressed air, steam, carbon dioxide or nitrogen. In an example, the gas is compressed air.

The gas may be configured to be injected at any suitable pressure. In an embodiment, the gas is configured to be injected at a pressure from about 0.05 bar to about 4 bar, or from about 0.1 bar to about 3 bar, or from about 0.3 bar to 1.5 bar, or preferably from about 0.1 bar to about 1.2 bar. In some examples, the gas is injected at a pressure from about 0.1 bar to 0.4 bar. In some examples, the gas is injected at a pressure from about 0.5 bar to about 3 bar.

In some embodiments, the gas is configured to be injected in pulses, in other words, the gas is injected intermittently. In other embodiments, the gas is configured to be injected at a continuous pressure.

In a preferred embodiment, the gas is configured to be injected as the extrusion composition exits the nozzle, in other words, the gas outlets are positioned at the distal end of the nozzle. In other embodiments, the gas may be configured to be injected into the extrusion composition before the extrusion composition leaves the nozzle.

The nozzle may additionally comprise at least one gas inlet, which is configured to be attached to a gas supply for the inflow of gas, and at least one gas channel, which is configured to transfer the gas from the gas inlet to the gas outlet. The gas inlet may be present anywhere along the length of the nozzle.

The nozzle may be made of any suitable material, such as steel, tool steel, PTFE, PEEK, tungsten carbide, silicon carbide or stainless steel. In an example, the nozzle is made of stainless steel.

Herein is also provided an extrusion apparatus comprising an extruder comprising a nozzle the nozzle, comprising

at least one extrusion channel that is configured to form at least two extruded layers
and at least one gas outlet configured to inject gas between the at least two extruded layers, wherein the gas outlet is connected to a gas supply.

The extrusion apparatus may comprise any nozzle described herein. In a preferred embodiment, the extrusion apparatus additionally comprises a barrel that includes at least one screw, and optionally a feeding hopper. The feeding hopper may feed an extrusion composition into the barrel. The barrel conveys an extrusion composition to the nozzle, and the extrusion composition is extruded through the nozzle to form at least two extruded layers. In a preferred embodiment, the nozzle is detachable from other parts of the extrusion apparatus, for example, the barrel.

The feeding hopper is where an extrusion composition is added to the extruder. The feeding hopper both holds and feeds the extrusion composition into the barrel. The extrusion composition may be added to and/or fed through the feeding hopper by gravity or by negative pressure.

The barrel conveys an extrusion composition to the nozzle. The barrel may have a single hollow chamber if the two extruded layers are formed of the same material. The barrel may have at least two hollow chambers if the at least two extruded layers are formed from a different material.

The at least one screw may be a single screw or a twin screw. The at least one screw may rotate at a speed of from 50 rpm to 400 rpm, optionally a speed of from 80 rpm to 250 rpm, optionally a speed of from 120 rpm to 220 rpm, optionally a speed of from 140 rpm to 200 rpm

The at least one screw may be configured to apply a specific mechanical energy (SME) from 40 kWhkg⁻¹ to 130 kWhkg⁻¹, optionally from 50 kWhkg⁻¹ to 110 kWhkg⁻¹, optionally from 60 kWhkg⁻¹ to 115 kWhkg⁻¹, optionally from 65 kWhkg⁻¹ to 115 kWhkg⁻¹. The SME may be applied by the at least one screw.

In an embodiment, the barrel may comprise heaters. The barrel, or at least some parts of the barrel, may be heated to a temperature of at least 50° C., least 60° C., optionally of at least 70° C., optionally at least 80° C., optionally at least 90° C., or at least 95° C., or at least 100° C., or at least 110° C. The barrel may be split into two or more sections, wherein the two or more sections are at different temperatures.

In an embodiment, the extrusion apparatus may further comprise a rolling assembly, configured to roll the extruded layers after exiting the nozzle.

In an embodiment, the extrusion apparatus may further comprise a knife assembly, configured to cut the extruded layers after exiting the nozzle.

In an embodiment, the extrusion apparatus may comprise a rolling assembly and a knife assembly.

### EXAMPLES

### Example 1

The following illustrate examples of the compositions, methods and other aspects described herein. Thus, these Examples should not be considered as limitations of the present disclosure, but are merely in place to teach how to make embodiments of the edible animal chew, and to illustrate embodiments of the method.

### Example Compositions

The example compositions herein involved the combination of several important components that work symbiotically to produce the final material, this includes:

(i) Drinde B95 SF—Essentia Proteins

Pork rind is cooked in pork fat, and the cooked rind is milled to have the following particle size.

TABLE 1

| Pore Size/ | Pore Size/ | |
|---|---|---|
| Millimeter | Millimeter | % Retained |
| 0.1 | 100 | 97% |
| 0.15 | 150 | 92% |
| 0.25 | 250 | 40% |
| 0.35 | 350 | 21% |
| 0.5 | 500 | 15% |
| 1 | 1000 | 11% |
| 2 | 2000 | 0% |

The product contains ˜84-87 wt. % pork skin protein (60-70 wt. % collagen), fat (7-15%), salt <1.5 wt. %, moisture 8-12 wt. %.

(ii) Soy Bean Powder

Defatted soy bean is either available as either pellets or meal, which includes soy bean protein.

In some examples, 8 mm pellets were ground to form a powder (Henry Bells and Co, West End Approach, Leeds, LS27 0NB, United Kingdom). The soy bean powder had the following average particle size distribution and protein content.

TABLE 2
Average particle size Distribution

| Retained on: | | | | |
|---|---|---|---|---|
| (wt %) | Units | Target | Min | Max |
| 250 μm | % (by wt) | 0 | n/a | 0 |
| 100 μm | % (by wt) | 8.75 | 4.5 | 30 |
| Pan | % (by wt) | 91.25 | 70 | 95.5 |

Protein

| | | | | |
|---|---|---|---|---|
| Soy bean Protein | % (by wt) | 42 | 37 | 47 |

(iii) Starch—The starch used in these Examples is a powdered native potato starch, however it is envisaged that a waxy maize starch, acetylated waxy maize starch, a hydroxypropylated waxy maize starch, an enzyme treated waxy maize starch or a waxy starch from any other species may be used.

(iv) Octenyl succinate modified starch (E1450)

The octenyl succinate modified starch used in these examples is Clearam® CO 01.

### Compositional Testing

The above components were mixed in varying proportions to form a pre-blend composition, as shown in Table 3.

TABLE 3

| | | | Clearam ® | |
|---|---|---|---|---|
| | | | CO 01 | |
| | Potato | Drinde B95 SF | (Octenyl | |
| Pre-blend | Starch | (Pork rind | succinate | Soya Bean |
| Composition | (%) | component) | modified starch) | Powder (%) |
| A | 60 | 20 | 0 | 20 |
| B | 20 | 60 | 0 | 20 |
| C | 20 | 20 | 20 | 40 |
| D | 20 | 40 | 20 | 20 |
| E | 50 | 10 | 20 | 20 |
| F | 50 | 10 | 0 | 40 |
| G | 50 | 10 | 0 | 40 |
| H | 50 | 10 | 20 | 20 |
| I | 20 | 20 | 20 | 40 |
| J | 20 | 60 | 0 | 20 |

The various powdered compositions were extruded into strips using cooker extrusion. The extrusion settings were normalised for energy input (SME) by altering extruded screw speed between runs.

The final compositions are shown in Table 4.

TABLE 4

| | Potato | Drinde B95 | Clearam ® CO 01 | | | |
|---|---|---|---|---|---|---|
| | Starch | (Pork rind | (Octenyl succinate | Soya Bean | | |
| Composition | (%) | component) | modified starch) | Powder (%) | Water | Glycerol |
| A | 39 | 13 | 0 | 13 | 13 | 22 |
| B | 13 | 39 | 0 | 13 | 13 | 22 |
| C | 13 | 13 | 13 | 26 | 13 | 22 |
| D | 13 | 26 | 13 | 13 | 13 | 22 |
| E | 32.5 | 6.5 | 13 | 13 | 13 | 22 |
| F | 32.5 | 6.5 | 0 | 26 | 13 | 22 |
| G | 32.5 | 6.5 | 0 | 26 | 13 | 22 |
| H | 32.5 | 6.5 | 13 | 13 | 13 | 22 |
| I* | 13 | 13 | 13 | 26 | 13 | 22 |
| J | 13 | 39 | 0 | 13 | 13 | 22 |

*I is a technical replicate of C.

### Texture Profile Analysis

Textural profile analysis (TPA) allows the determination of several parameters that characterise the texture of the sample.

The following equipment and method was used:

### Equipment

(i) Stable Micro Systems TA HD plus;

(ii) Tensile rig (A/HDT)—Max. load 500 kg;

(iii) Secateurs (only required for testing Pedigreen Dentastix)

(iv) Tensile cutter (ISO 527-2, 75 mm long, 10 mm wide, 5 mm in centre)—Zwick Roell;

(v) 100 kg or 500 kg load cell

### Texture Analyser General Method

(i) An extruded strip is cut into a tensile bar using an ISO-527-2 stamp (Zwick Roell).

(ii) The tensile bar is placed into the lower grips of a tensile rig, so that the full shoulder of the test piece is exposed, and tightened enough such that the product does not slip during testing, but not so that the product breaks.

(iii) The upper grips of the tensile rig are positioned to align with the test piece, again, so that the full shoulder of the test piece is exposed.

(iv) Tension or slack in the test-piece is minimised.

(v) The grips are moved apart by a texture analyser (TA) at 1 mm/s and the resistive force is recorded by the sensor through the breaking point of the test piece.

Before testing, the extruded samples are incubated at 22° C. for 1 hour prior. The samples are then laid flat in the centre of the flat surface such that the sample is compressed in the longitudinal direction. Using a texture analyser (Stable Micro Systems TA HD plus) a compression plate of a size sufficient to compress the entire surface of the sample is used to compress the product to 50% strain, or 50% of its overall height at a speed of 1 mm/s. In the case of a sample with a 10 mm height, the distance to 50% strain is 5 mm. Once the required strain distance is reached, the probe is moved upwards at a rate of 1 mm/s and stops 10 mm above the base plate, the original sample height. After completing the first compression cycle, the compression plate pauses for a period of 5 seconds in which the product, dependent on its material properties, can recover some of its original shape and form. The second compression cycle is then carried out. The compression plate is moved down to the distance that was required to achieve 50% strain during the first compression (for the 10 mm height sample, 5 mm) at a speed of 1 mm/s. After reaching the required strain distance, the probe is then moved upwards immediately at a rate of 1 mm/s and stops at the original probe height.

### Data Analysis

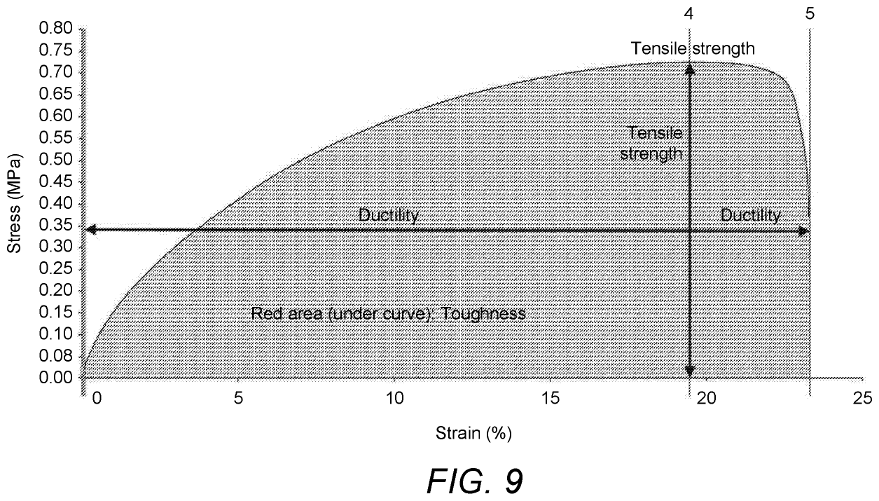

FIG. 9 shows a plot of the force responsive curve from a texture analysis test plotted on an axes of stress (MPa) versus strain (%). The dimensions of the central break point (width and depth) are accounted for in the plot. From this plot, the following parameters can be determined:
Tensile strength (MPa)—the peak resistive force from the test piece
Ductility (%)—the elongation to break, i.e., the ability to deform without failure
Toughness (MPa) is the area under the curve and provides a compound measure taking into account both the tensile strength and the ductility.

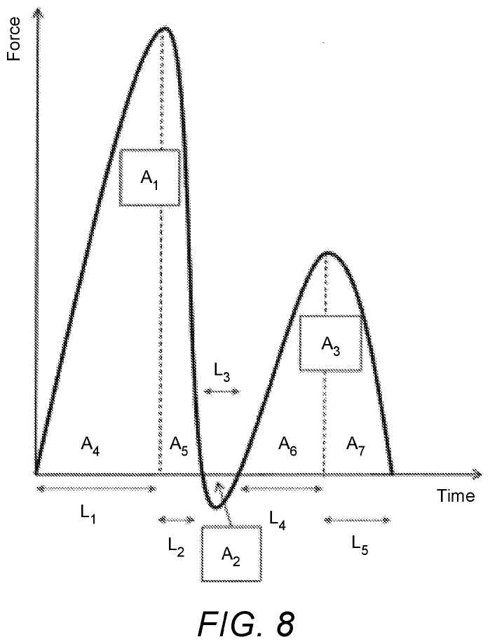

A schematic of a Texture Profile Analysis measurement is shown in FIG. 8. As can be seen, the measurement is presented as the force experienced by the probe against the time elapsed. This is a well-established technique to emulate the compression from a first bite, followed by a second bite at the same location. With reference to FIG. 8:

L1 corresponds to the period in which the probe is moving in the downward direction during the first compression and a force that is measured.

L2 corresponds to the period in which the probe is moving in the upward direction during the first compression, and a force is measured.

L4 corresponds to the period in which the probe is moving in the downward direction during the second compression and a positive force is measured.

L5 corresponds to the period in which the probe is moving in the upward direction during the second compression test and a positive force is measured.

A1 corresponds to the area under the curve of a measured force during the period in which the probe is moving in both the downward direction and in the upward direction (a full single cycle in which pressure is exerted and released) during the first compression-release cycle.

A2 corresponds to the area above the curve of a measured force during the period in which the probe is moving close to its original position between the first and second compression cycles. A negative force reading may be observed if the product displays any adhesion or grip to the probe surface. Thus, A2 is not always observed as a parameter especially where the product surface displays low surface stickiness or grip.

A3 corresponds to the area under the curve of a measured force during the period in which the probe is moving in both the downward direction and in the upward direction (a full single cycle in which pressure is exerted and released) during the second compression-release cycle.

A4 corresponds to the area under the curve of a measured force during the period in which the probe is moving in the downward direction during the first compression.

A5 corresponds to the area under the curve of a measured force during the period in which the probe is moving in the upward direction (releasing pressure) during the first compression.

A6 corresponds to the area under the curve of a measured force during the period in which the probe is moving in the downward direction during the second compression.

A7 corresponds to the area under the curve of a measured force during the period in which the probe is moving in the upward direction (releasing pressure) during the second compression.

These parameters can be used to determine the Instantaneous Retarded Springiness (IRS), using the following formula:

$$I R S ( \% ) = \frac{L 1}{L 2} \times 100$$

The IRS is a measure of the spring back during the first compression and is therefore indicative of the springiness of the sample directly after the compressive downstroke. The IRS is used to assess the malleability of the material. The material needs to be malleable, such that the material can be post-formed and stylized.

### Results

Each composition was assessed for water activity, toughness and IRS, as shown in Table 5.

Water activity was measured using an AQUA LAB 4TEV device by Decagon Devices. Samples were cut up into pieces with a 0.5 mm diameter and placed into a sample holder before being loaded into the machine. After the moisture in the atmosphere above the sample reaches equilibrium, a measurement is taken and displayed on the digital screen.

TABLE 5

| Pre-blend | Water activity | Toughness | IRS |
|---|---|---|---|
| Composition | (Aw) | (MPa) | (%) |
| A | 0.616 | 211.598 | 65.69 |
| B | 0.597 | 380.702 | 59.55 |
| C | 0.591 | 117.751 | 46.46 |
| D | 0.566 | 231.454 | 50.35 |
| E | 0.638 | 83.117 | 43.55 |
| F | 0.635 | 136.774 | 61.64 |
| G | 0.643 | 143.872 | 65.84 |
| H | 0.655 | 47.84 | 36.82 |
| I* | 0.543 | 115.134 | 53.69 |
| J | 0.586 | 335.905 | 63.03 |

*I is a technical replicate of C.

Differences in measured properties of technical replicates C and I gives a good indication of the error associated with measured properties. This gives a standard error of ±8.8% for Aw, ±2.3% for toughness and ±15% for IRS for the experimental procedure.

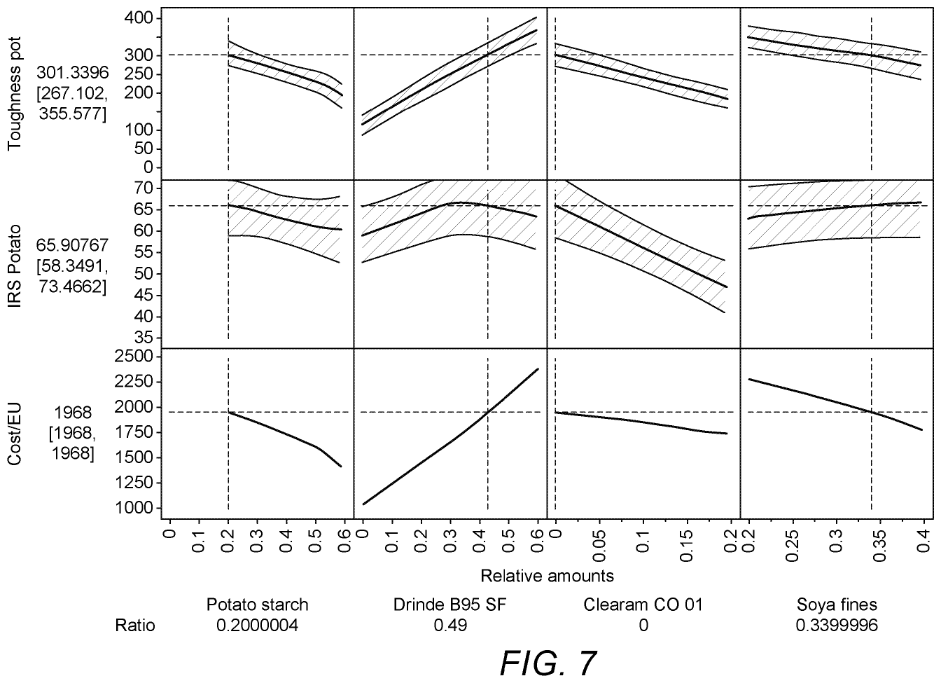

FIG. 7 shows a graphical representation of trends for cost (Euro), toughness (MPa), and Instantaneous Retarded Springiness (IRS, %) for the components used in further compositional testing. The % of ingredients is expressed as the % of each respective component in the powders preblend.

As is shown in FIG. 7, an increase in the pork rind component correlates with increased toughness of the product, which is indicative of long lasting chew. A balance of components, was required for an acceptable IRS. IRS is inversely proportional to plasticity, and a lower IRS value indicates a composition that is more easily post-formed and stylised, which can retain its shape after deformation. These results were used to determine the optimal amounts of each component, see Table 6.

TABLE 6

| | Exemplary | |
|---|---|---|
| Component | range | Optimal |
| Potato | 0 wt. % to 40% wt. % | 13 wt. % |
| Starch (%) | | |
| Drinde B95 SF | 13 wt. % to 52 wt. % | 30 wt. % |
| (Pork rind | | |
| component) | | |
| Animal skin | ~7 wt. % to 47 wt. % | ~18 wt. % to 27 wt % |
| protein | | |
| Animal fat | ~0.5 wt. % to 8 wt. % | ~2 wt. % to 4.5 wt. % |
| Clearam CO 01 | 0 wt. % to 15 wt. % | 0 wt. % |
| (Octenyl | | |
| succinate | | |
| modified | | |
| starch) | | |
| Soya Bean | 13 wt. % to 26 wt. % | 22 wt. % |
| Powder (%) | | |
| Soy bean | ~4 wt. % to | ~8 wt. % to 10.5 wt. % |
| protein | about 13 wt. % | |

The example compositions herein can be used to produce a material that is viscoplastic when hot to the extent that the composition can be manipulated in a variety of ways to yield (when cooled to room temperature) a product with the same sensory characteristics resembling ‘leather’ or ‘hide’. The resultant product has a tough texture that can be chewed for an extensive period of time. The products have a suitable tensile toughness, and in some cases, a very desirable tensile toughness which is greater than 150 MPa, 200 MPa, or 300 MPa. The edible animal chews have good material properties.

Without being bound by theory, the animal skin protein, which comprises fibrous collagen, is responsible for a high tensile toughness in the final product that is resistant to breakdown during chewing. The resultant edible animal chew therefore has a long lasting time.

The soybean protein has emulsifying properties and is believed to be important for: (i) binding the fat in the composition; (iii) controlling the water activity; and (iii) supporting the collagen component of the animal skin protein (the collagen triple helix is covered in hydrophobic regions which is thought to integrate more efficiently with the surrounding matrix in the presence of an emulsifying agent). This results in a product with good overall homogeneity that has a viable surface finish. The controlled water activity results in a product that is safe from a microbiological perspective and the resultant product remains desirably tough.

The starch may optionally be added to help to improve the viscoplastic properties of the composition, and/or reduce the costs of the overall composition. The octenyl succinate modified starch may optionally be used as an additional emulsifying component.

Critically, the material is viscoplastic and malleable with a non-sticky surface as it exits the extruder die/nozzle. This allows for the product to be post-formed into a variety of different shapes, styles and appearances, to give the resemblance of a professionally finished leather product.

Comparative prototype products in which soy bean protein was omitted (i.e. products that just contained pork skin protein, fat, and starch) were found to be excessively sticky at the surface and were not suitable for extrusion.

### Extrusion Method

Edible animal chews were formed comprising the exemplary compositions as described above. Pork skin protein, pork fat and soybean protein were mixed, optionally in the presence of native potato starch and/or octenyl succinate to form a pre-blend composition.

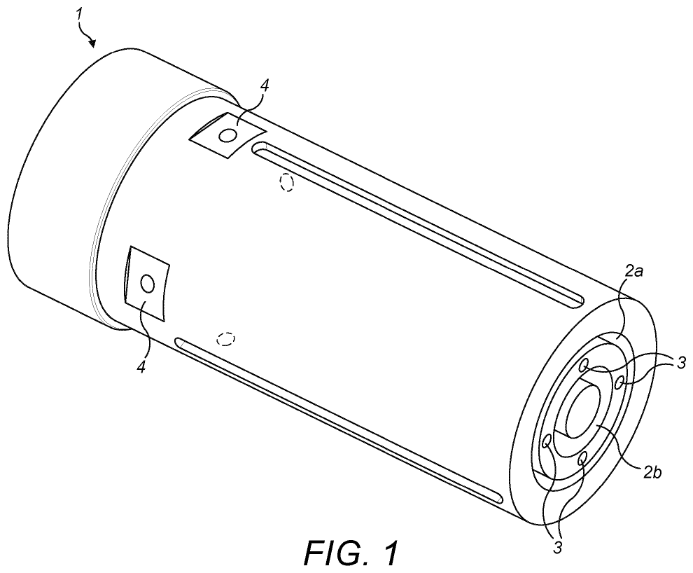

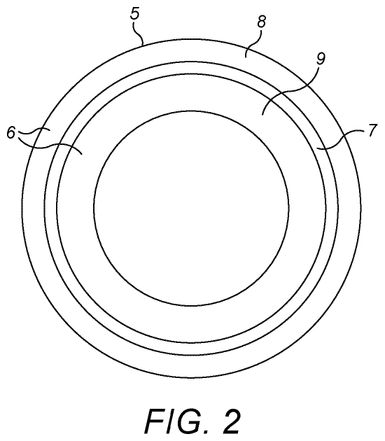

The pre-blend composition was mixed with water and glycerol and was conveyed through a barrel extruder with a single chamber. The extrusion composition was then extruded through a stainless steel nozzle as shown in FIG. 1. The nozzle comprises two concentric circular extrusion channels and gas outlets disposed between the two concentric circular extrusion channels which inject air between the two extruded layers. The resultant product has two extruded layers with an air-gap between at least a portion of the at least two extruded layers. The cross-section of the edible animal chew is shown in FIG. 2.

The extrusion conditions are shown in Table 7.

TABLE 7

| | |
|---|---|
| Powders kg/h | 56 |
| Water kg/h | 5 |
| Glycerol kg/h | 13 |
| Specific Mechanical Energy (SME) | 90 |
| Barrel temperature (° C.) | B1: Passive |
| | B2: 110° C. |
| | B3: 110° C. |
| | B4: Passive |
| | B5: 90° C. |
| | B6: 70° C. |
| | B6: 70° C. |
| Vacuum | 0.5 bar |
| Air injection pressure (Pa) | 0.8 bar |

The resultant example edible animal chew had the following dimensions as shown in Table 8.

TABLE 8

| | | |
|---|---|---|
| Length (cm) | 150 | mm |
| Thickness of outer | 1.5 | mm |
| extruded layer (mm) | | |
| Thickness of inner | 7 | mm |
| extruded layer (mm) | | |
| Diameter of outer | 45 | mm |
| extruded layer (mm) | | |
| Diameter of inner | 33 | mm |
| extruded layer (mm) | | |
| Average size of air- | 5 | mm |
| gap between the two | | |
| extruded layers (mm) | | |

| | |
|---|---|
| Pattern | Strips External (e.g. |
| | as shown in FIG. 3) |

Comparative extrusion processes that to do not inject air between the two extruded layers were found to be insufficient to deliver edible animal chews with desirable aesthetic properties. Without air injection, a vacuum formed between the layers and cuts had to be made to the outer layer to artificially create an air-gap.

### Example 2

### Example Compositions

The example compositions herein involved the combination of several important components that work symbiotically to produce the final material, this includes:
(i) Drinde B95 SF—Essentia Proteins
Pork rind is cooked in pork fat, and the cooked rind is milled to have the following particle size.

TABLE 1

| Pore Size/ | Pore Size/ | |
|---|---|---|
| Millimeter | Millimeter | % Retained |
| 0.1 | 100 | 97% |
| 0.15 | 150 | 92% |
| 0.25 | 250 | 40% |
| 0.35 | 350 | 21% |
| 0.5 | 500 | 15% |
| 1 | 1000 | 11% |
| 2 | 2000 | 0% |

(ii) Tubermine FV—Roquette
Potato protein supplied as an off-white powder with moisture content of 8% maximum, protein content 77% minimum and ash content of approximately 3%.
(iii) Starch—The starch used in these examples is a powdered native potato starch however it is envisaged that a waxy maize starch, acetylated waxy maize starch, a hydroxypropylated waxy maize starch, an enzyme treated waxy maize starch or a waxy starch from any other species may be used.

### Composition Testing

The above components were mixed in varying proportions to form a pre-blend composition, as shown in Table 2.

TABLE 2

| | Potato | Drinde B95 SF | Potato | |
|---|---|---|---|---|
| Pre-blend | Starch | (Pork Rind | Protein | Potassium |
| Composition | (%) | component) (%) | (%) | Sorbate |
| A | 20 | 45 | 34 | 0.2 |
| B | 22 | 45 | 32 | 0.2 |
| C | 24 | 45 | 30 | 0.2 |
| D | 34 | 47 | 20 | 0.2 |

In this Example in tables 2 and 3 showing wt % quantities, the wt % values are given to 2 significant figures (for values above 1) or 1 decimal place (for values below 1). The compositions are complete, and no other ingredients are present.

The various powdered compositions were extruded into a nozzle using cooker extrusion. The extrusion settings were normalised for energy input (SME) by altering extruded screw speed between runs.

The final compositions are shown in Table 3

TABLE 3

| | Potato | Drinde B95 | Potato | | | |
|---|---|---|---|---|---|---|
| | Starch | SF (Pork Rind | Protein | Potassium | Glycerol | Water |
| Composition | (%) | component) (%) | (%) | Sorbate (%) | (%) | (%) |
| A | 15 | 34 | 25 | 0.2 | 17 | 6.7 |
| B | 16 | 34 | 24 | 0.2 | 17 | 6.7 |
| C | 18 | 34 | 22 | 0.2 | 17 | 6.7 |
| D | 25 | 34 | 15 | 0.2 | 17 | 6.7 |

### Texture Profile Analysis

Textural profile analysis (TPA) allows the determination of several parameters that characterise the texture of the sample.

The following equipment and method was used:

### Equipment

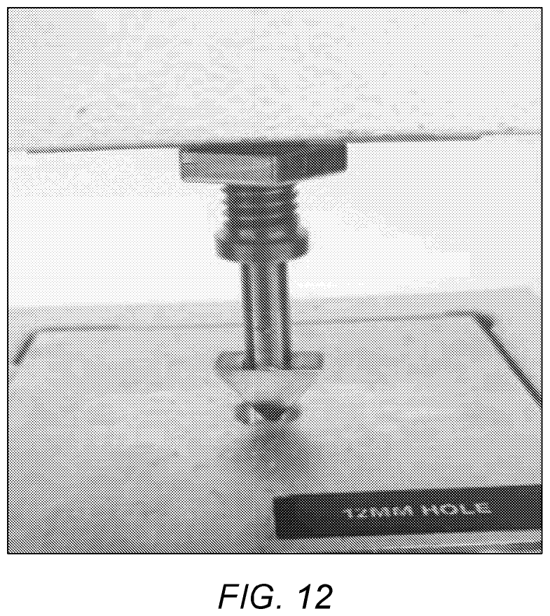

(i) Stable Micro Systems TA HD plus:
(ii) Test probe—Pyramidal probe 70° major angle, 30° minor angle 1 mm radius tip (specifically manufactured)*
(iii) Baseplate—Steel plate with 12 mm diameter hole (specifically manufactured)*
(iv) Secateurs
(v) 100 kg load cell (Stable micro systems) *Baseplate and test probe of the Stable Micro Systems TA HD plus shown in more detail in FIG. 12

### Texture Analyser General Method

(i) Extruded product is placed onto the steel baseplate with the 12 mm hole located underneath the centre of the product
(ii) The 100 kg load cell and test probe is fitted to the stable micro systems TA HD plus texture analysis machine.
(iii) Probe speed must be maintained at 1 mm/s during the time at which the probe has contacted the product and the force is being measured.

In order to assess hardness, the following test parameters to be adhered to when performing this analysis.

The product is to be incubated to 22° C. prior to testing. Analysis should be started within 2 minutes of removal from the incubator to ensure that any change from the incubated temperature is minimized.

Probe speed must be maintained at 1 mm/s during the time at which the probe has contacted the product and the force is being measured. The measurement continues until the force reading reaches 800N and the test stops or at the zero base calibration point of the instrument.

A force of 800N or greater is a fail in this test as it represents a fracture risk for an animal. A increase in tooth fracture events occurs above 800N, which lies below the 15th Percentile of the fracture data. Underlying issues with tooth quality can result in fracture at forces that are impractical to avoid. The forces required to fracture a tooth are not commonly deployed by dogs during voluntary chewing but dogs can and do deploy higher levels of chewing force regularly.

### Data Analysis

FIG. 7) shows a plot of the force responsive curve from a texture analysis test plotted on an axes of force (kg) over distance (mm). From this plot, the following parameter can be determined:
Peak force (kg)—The maximum force encountered on the product in one measurement cycle without failure.

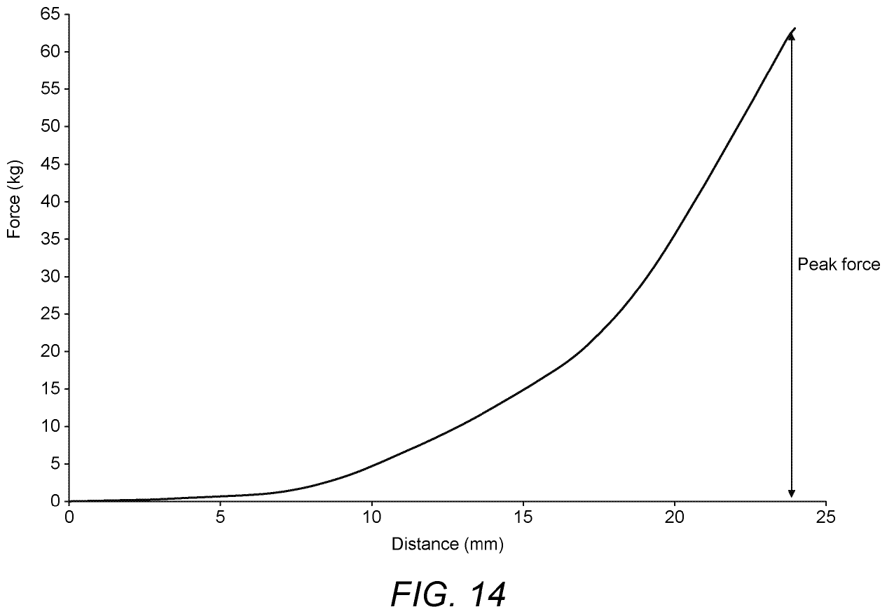

The curve in FIG. 14 shows the amount of force applied to the product as the product is compressed. The probe moved at a constant speed of 1 mm/s.

A Failure would occur if the peak force would reach ^{˜}81.6 kg (800 newtons) or if the probe reaches the zero base calibration point.

The force data gained from the texture measurement was converted into newtons.

### Results

Each composition was assessed for water activity, hardness, as shown in Table 4.

Water activity was measured using an AQUA LAB 4TEV device by Decagon Devices. Samples were cut up into pieces with a 0.5 mm diameter and placed into a sample holder before being 25 loaded into the machine. After the moisture in the atmosphere above the sample reaches equilibrium, a measurement is taken and displayed on the digital screen.

TABLE 4

| | Water | |
|---|---|---|
| Composition | activity (Aw) | Hardness (N) |
| A | 0.591 | 784.7772 |
| B | 0.584 | 662.4392 |
| C | 0.584 | 540.062 |
| D | 0.595 | 472.2 |

Minimal variation of water activity was seen across all composition.

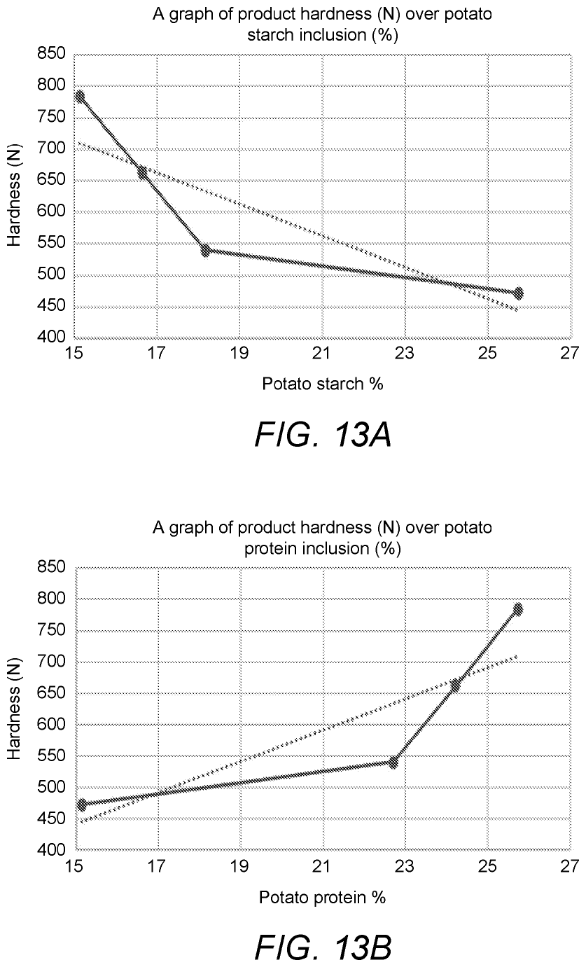

FIG. 13A shows the relationship between potato starch levels, potato protein levels and hardness for the components. The hardness is measured be force (N) and the ingredients are expressed as the % of each respective component in the powders pre blend.

As is shown in FIG. 13B, a reduction of potato protein and increase in potato starch correlates with a decrease in hardness of the product. A balance of components was required for an acceptable hardness. A level of hardness is needed for a long lasting chew but hardness may have an effect on product forming and aesthetic characteristics. These results were used to determine the optimal amounts of each component, see table 5.

TABLE 5

| | Exemplary | |
|---|---|---|
| Component | range | Optimal |
| Potato | 15 wt. % to 30 wt. % | 17% |
| Starch | | |
| Drinde B95 SF | 13 wt. % to 52 wt. % | ~30 wt. % |
| (Pork rind | | |
| component) | | |
| Animal skin | ~7 wt. % to 47 wt. % | ~18 wt. % to 27 wt. % |
| protein | | |
| Animal Fat | ~0.5 wt. % to 8 wt. % | ~2 wt. % to 4.5 wt. % |
| Potato | 15 wt. % to 28 wt. % | ~22 wt. % to 24 wt. % |
| Protein | | |

The example compositions herein can be used to produce a material that is viscoplastic when hot to the extent that the composition can be manipulated in a variety of ways to yield (when cooled to room temperature) a product with the same sensory characteristics resembling ‘leather’ or ‘hide’. The resultant product has a tough texture that can be chewed for an extensive period of time.

The potato protein has emulsifying properties and is believed to be important for: (i) binding the fat in the composition; (ii) controlling the water activity; and (iii) supporting the collagen component of the animal protein (the collagen triple helix is covered in hydrophobic regions which is thought to integrate more efficiently with the surrounding matrix in the presence of an emulsifying agent). This results in a product with good overall homogeneity that has a viable surface finish. The controlled water activity results in a product that is safe from a microbiological perspective and the resultant product remains desirably tough.

The starch may optionally be added to help to improve the viscoplastic properties of the composition, and/or reduce the costs of the overall composition.

The material is viscoplastic and malleable with a non-sticky surface as it exits the extruder die/nozzle. This allows for the product to be post-formed into a variety of different shapes, styles and appearances, to give the resemblance of a professionally finished leather product.

Potato protein would be a candidate plant protein to make the composition grain free with the removal of soy bean protein.

### Extrusion Method

Edible animal chews were formed comprising the exemplary compositions as described above. Pork skin protein, pork fat and potato protein were mixed, optionally in the presence of native potato to form a pre-blend composition.

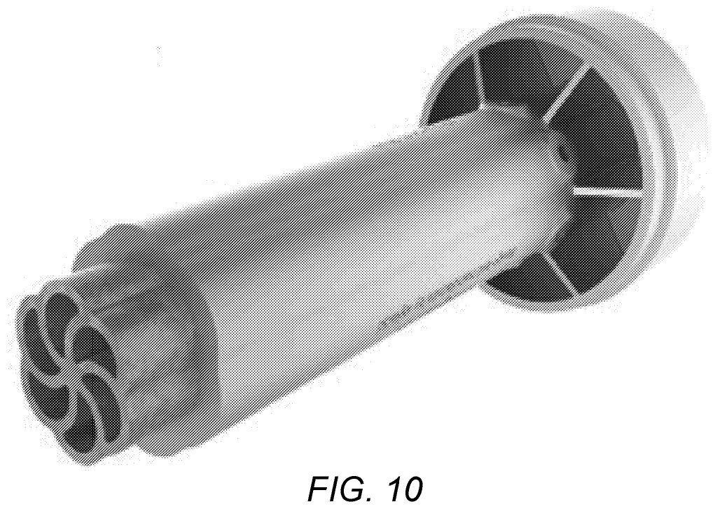

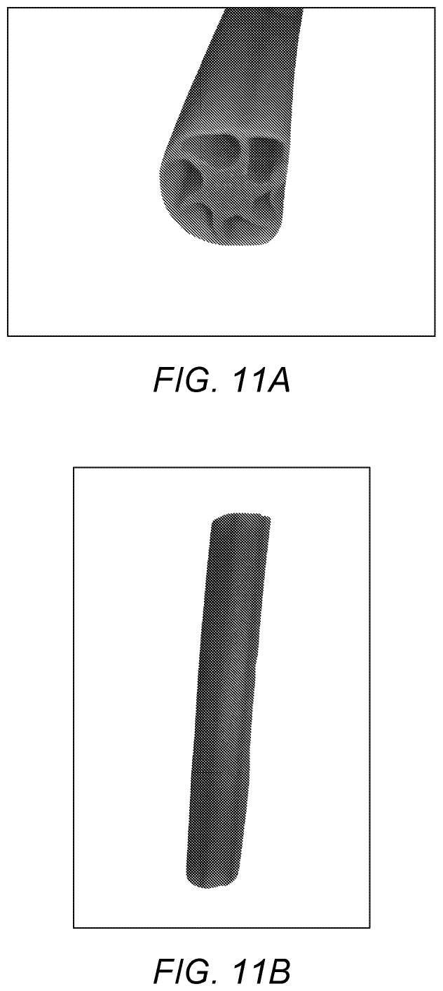

The pre-blend composition was mixed with water and glycerol and was conveyed through a barrel extruder with a single chamber. The extrusion composition was then extruded through a stainless steel nozzle as shown in FIG. 10. The nozzle comprises a circular extrusion channel with an inner star shaped motif and gas outlets disposed between the arms of the star shape extrusion channel which inject air between the two extruded layers. The resultant product has multiple extruded layers with an air-gap between at least a portion of the at least two extruded layers. The cross-section of the edible animal chew is shown in FIG. 11A.

The extrusion conditions are shown in Table 5

TABLE 5

| | |
|---|---|
| Powders kg/h | 56 |
| Water kg/h | 5 |
| Glycerol kg/h | 13 |
| Specific Mechanical Energy (SME) | 90 |
| Barrel Temperature (° C.) | B1: Passive |
| | B2: 110° C. |
| | B3: 110° C. |
| | B4: Passive |
| | B5: 90° C. |
| | B6: 70° C. |
| | B7: 70° C. |
| Vacuum | 0.5 Bar |
| Air Injection pressure | 0.8 Bar |

The resultant example edible animal chew had the following dimensions as shown in Table 6

TABLE 6

| | |
|---|---|
| Length (mm) | 150 |
| Diameter (mm) | 28 |
| Core Diameter (mm) | 11 |
| Thickness of outer | 1 |
| extruded layer (mm) | |
| Thickness of motif arms (mm) | 1.5 |
| Average size of air gap | 8 |
| between motif arms (mm) | |
| Pattern | Shown in FIGS. 10 and 11A |

### Example 3

The following illustrate examples of the compositions, methods and other aspects described herein. Thus, these Examples should not be considered as limitations of the present disclosure, but are merely in place to teach how to make embodiments of the edible animal chew, and to illustrate embodiments of the method.

### Example Compositions

The example compositions herein involved the combination of several important components that work symbiotically to produce the final material, this includes:
(i) Drinde B95 SF—Essentia Proteins
Pork rind is cooked in pork fat, and the cooked rind is milled to have the following particle size.

TABLE 1

| Pore Size/ | Pore Size/ | |
|---|---|---|
| Millimeter | Millimeter | % Retained |
| 0.1 | 100 | 97% |
| 0.15 | 150 | 92% |
| 0.25 | 250 | 40% |
| 0.35 | 350 | 21% |
| 0.5 | 500 | 15% |
| 1 | 1000 | 11% |
| 2 | 2000 | 0% |

(ii) Soy bean powder Defatted soy bean is either available as either pellets or meal, which includes soy bean protein. In some examples, 8 mm pellets were ground to form a powder (Henry Bells and Co, West End 25 Approach, Leeds, LS27 0NB, United Kingdom). The soy bean powder had the following average particle size distribution and protein content.
(iii) Starch—The starch used in these examples is a powdered native potato starch however it is envisaged that a waxy maize starch, acetylated waxy maize starch, a hydroxypropylated waxy maize starch, an enzyme treated waxy maize starch or a waxy starch from any other species may be used.

### Composition Testing

The above components were mixed in varying proportions to form a pre-blend composition, as shown in Table 2.

TABLE 2

| | | Drinde B95 SF | | |
|---|---|---|---|---|
| Pre-blend | Potato Starch | (Pork Rind | Soya Bean | Potassium |
| Composition | (%) | component) (%) | Powder (%) | Sorbate |
| A-G | 20 | 45 | 34 | 0.2 |

In this Example in tables 2 and 3 showing wt % quantities, the wt % values are given to 2 significant figures (for values above 1) or 1 decimal place (for values below 1). The compositions are complete, and no other ingredients are present.

The various powdered compositions were extruded into (NOZZLE) using cooker extrusion. The extrusion settings were normalised for energy input (SME) by altering extruded screw speed between runs.

The final compositions are shown in Table 3

TABLE 3

| | Potato | Drinde B95 | Soya Bean | | | |
|---|---|---|---|---|---|---|
| | Starch | SF (Pork Rind | Powder | Potassium | Glycerol | Water |
| Composition | (%) | component) (%) | (%) | Sorbate (%) | (%) | (%) |
| A | 15 | 35 | 25 | 0.2 | 17 | 6 |
| B | 15 | 35 | 25 | 0.2 | 15 | 10 |
| C | 15 | 35 | 25 | 0.2 | 13 | 10 |
| D | 15 | 35 | 25 | 0.2 | 12 | 12 |
| E | 15 | 35 | 25 | 0.2 | 10 | 13 |
| F | 15 | 35 | 25 | 0.2 | 9 | 14 |
| G | 15 | 35 | 25 | 0.2 | 8 | 16 |

### Texture Profile Analysis

Textural profile analysis (TPA) allows the determination of several parameters that characterise the texture of the sample.

The following equipment and method was used:

### Equipment

(vi) Stable Micro Systems TA HD plus:
(vii) Compression Plate rated to 500 kg
(viii) Base plate—Steel plate (specifically manufactured)
(ix) Secateurs
(x) 500 kg load cell (Stable micro systems)

### Texture Analyser General Method

Before testing, the extruded samples are incubated at 22° C. for 1 hour prior. The samples are then laid flat in the centre of the flat surface such that the sample is compressed in the longitudinal direction. Using a texture analyser (Stable Micro Systems TA HD plus) a compression plate of a size sufficient to compress the entire surface of the sample is used to compress the product to 50% strain, or 50% of its overall height at a speed of 1 mm/s. In the case of a sample with a 10 mm height, the distance to 50% strain is 5 mm. Once the required strain distance is reached, the probe is moved upwards at a rate of 1 mm/s and stops 10 mm above the base plate, the original sample height. After completing the first compression cycle, the compression plate pauses for a period of 5 seconds in which the product, dependent on its material properties, can recover some of its original shape and form. The second compression cycle is then carried out. The compression plate is moved down to the distance that was required to achieve 50% strain during the first compression (for the 10 mm height sample, 5 mm) at a speed of 1 mm/s. After reaching the required strain distance, the probe is then moved upwards immediately at a rate of 1 mm/s and stops at the original probe height.

### Data Analysis

A schematic of a Texture Profile Analysis measurement is shown in FIG. 8. As can be seen, the measurement is presented as the force experienced by the probe against the time elapsed. This is a well-established technique to emulate the compression from a first bite, followed by a second bite at the same location. With reference to FIG. 8:

L1 corresponds to the period in which the probe is moving in the downward direction during the first compression and a force that is measured.

L2 corresponds to the period in which the probe is moving in the upward direction during the first compression, and a force is measured.

L4 corresponds to the period in which the probe is moving in the downward direction during the second compression and a positive force is measured.

L5 corresponds to the period in which the probe is moving in the upward direction during the second compression test and a positive force is measured.

A1 corresponds to the area under the curve of a measured force during the period in which the probe is moving in both the downward direction and in the upward direction (a full single cycle in which pressure is exerted and released) during the first compression-release cycle.

A2 corresponds to the area above the curve of a measured force during the period in which the probe is moving close to its original position between the first and second compression cycles. A negative force reading may be observed if the product displays any adhesion or grip to the probe surface. Thus, A2 is not always observed as a parameter especially where the product surface displays low surface stickiness or grip.

A3 corresponds to the area under the curve of a measured force during the period in which the probe is moving in both the downward direction and in the upward direction (a full single cycle in which pressure is exerted and released) during the second compression-release cycle.

A4 corresponds to the area under the curve of a measured force during the period in which the probe is moving in the downward direction during the first compression.

A5 corresponds to the area under the curve of a measured force during the period in which the probe is moving in the upward direction (releasing pressure) during the first compression.

A6 corresponds to the area under the curve of a measured force during the period in which the probe is moving in the downward direction during the second compression.

A7 corresponds to the area under the curve of a measured force during the period in which the probe is moving in the upward direction (releasing pressure) during the second compression.

These parameters can be used to determine the Instantaneous Retarded Springiness (IRS), using the following formula:

$$I R S ( \% ) = \frac{L 1}{L 2} \times 100$$

The IRS is a measure of the spring back during the first compression and is therefore indicative of the springiness of the sample directly after the compressive downstroke. The IRS is used to assess the malleability of the material. The material needs to be malleable, such that the material can be post-formed and stylized.

### Results

Each composition was assessed for water activity, hardness, as shown in Table 4.

Water activity was measured using an AQUA LAB 4TEV device by Decagon Devices. Samples were cut up into pieces with a 0.5 mm diameter and placed into a sample holder before being 25 loaded into the machine. After the moisture in the atmosphere above the sample reaches equilibrium, a measurement is taken and displayed on the digital screen.

TABLE 4

| | Water | |
|---|---|---|
| Composition | activity (Aw) | IRS (%) |
| A | 0.57 | 64.57 |
| B | 0.64 | 63.95 |
| C | 62.93 | 63.58 |
| D | 0.66 | 59.71 |
| E | 0.65 | 60.55 |
| F | 0.70 | 64.52 |
| G | 0.73 | 63.52 |

Variation in water activity was seen and expected throughout the different compositions. Composition A-E were in an acceptable range in terms of risk for microbe growth. Composition F and G would require further study to understand the shelf life of the composition.

As is shown in FIG. 7, an increase in the pork rind component correlates with increased toughness of the product, which is indicative of long-lasting chew. A balance of components was required for an acceptable IRS. IRS is inversely proportional to plasticity, and a lower IRS value indicates a composition that is more easily post-formed and stylised, which can retain its shape after deformation. product forming and aesthetic characteristics.

The IRS % levels shown in composition A-G show that the range of water to glycerol ratios had minimal effect to IRS. The results are also comparable to previous tests.

These results were used to determine the optimal amounts of each component, see table 5.

TABLE 5

| | Exemplary | |
|---|---|---|
| Component | range | Optimal |
| Potato | 0 wt. % to 40 wt. % | 17% |
| Starch | | |
| Drinde B95 SF | 13 wt. % to 52 wt. % | ~30 wt. % |
| (Pork rind | | |
| component) | | |
| Animal skin | ~7 wt. % to 47 wt. % | ~18 wt. % to 27 wt % |
| protein | | |
| Animal Fat | ~0.5 wt. % to 8 wt. % | ~2 wt. % to 4.5 wt. % |
| Soya Bean | 13 wt. % to 26 wt. % | 25 wt. % |
| Protein | ~4 w.t % to | ~8 wt. % to 10.5 wt. % |
| | about 13 wt. % | |

The example compositions herein can be used to produce a material that is viscoplastic when hot to the extent that the composition can be manipulated in a variety of ways to yield (when cooled to room temperature) a product with the same sensory characteristics resembling ‘leather’ or ‘hide’. The resultant product has a tough texture that can be chewed for an extensive period of time.

The soy bean protein has emulsifying properties and is believed to be important for: (i) binding the fat in the composition; (ii) controlling the water activity; and (iii) supporting the collagen component of the animal protein (the collagen triple helix is covered in hydrophobic regions which is thought to integrate more efficiently with the surrounding matrix in the presence of an emulsifying agent). This results in a product with good overall homogeneity that has a viable surface finish. The controlled water activity results in a product that is safe from a microbiological perspective and the resultant product remains desirably tough.

The starch may optionally be added to help to improve the viscoplastic properties of the composition, and/or reduce the costs of the overall composition.

Critically, the material is viscoplastic and malleable with a non-sticky surface as it exits the extruder die/nozzle. This allows for the product to be post-formed into a variety of different shapes, styles and appearances, to give the resemblance of a professionally finished leather product.

Comparative prototype products in which soy bean protein was used in place of potato protein shown that more soy protein % was needed in the composition to achieve the desired hardness.

Potato protein would be a candidate plant protein to make the composition grain free with the removal of soy bean protein.

### Extrusion Method

Edible animal chews were formed comprising the exemplary compositions as described above. Pork skin protein, pork fat and potato protein were mixed, optionally in the presence of native potato to form a pre-blend composition.

The pre-blend composition was mixed with water and glycerol and was conveyed through a barrel extruder with a single chamber. The extrusion composition was then extruded through a stainless steel nozzle as shown in FIG. 10. The nozzle comprises a circular extrusion channel with an inner star shaped motif and gas outlets disposed between the arms of the star shape extrusion channel which inject air between the two extruded layers. The resultant product has multiple extruded layers with an air-gap between at least a portion of the at least two extruded layers. The cross-section of the edible animal chew is shown in FIG. 11A.

The extrusion conditions are shown in Table 6

TABLE 6

| | |
|---|---|
| Powders kg/h | 56 |
| Water kg/h | 5-12 |
| Glycerol kg/h | 6-13 |
| Specific Mechanical Energy (SME) | 90 |
| Barrel Temperature (° C.) | B1: Passive |
| | B2: 110° C. |
| | B3: 110° C. |
| | B4: Passive |
| | B5: 90° C. |
| | B6: 70° C. |
| | B7: 70° C. |
| Vacuum | 0.5 Bar |
| Air Injection pressure | 0.8 Bar |

The resultant example edible animal chew had the following dimensions as shown in Table 7

TABLE 7

| | |
|---|---|
| Length (mm) | 150 |
| Diameter (mm) | 28 |
| Core Diameter (mm) | 11 |
| Thickness of outer | 1 |
| extruded layer (mm) | |
| Thickness of motif arms (mm) | 1.5 |
| Average size of air gap | 8 |
| between motif arms (mm) | |
| Pattern | Shown in FIGS. 10 and 11A |

### Disclosed Herein is the Subject Matter in the Following Numbered Statements

1. An edible animal chew comprising at least two extruded layers, wherein at least one extruded layer comprises:
   animal skin protein, wherein the animal skin is porcine or bovine,
   animal fat, wherein the animal fat is porcine or bovine, and
   soybean protein, wherein there is an air-gap between at least a portion of the at least two extruded layers.
2. The edible animal chew according to statement 2, wherein the at least one extruded layer comprises about 7 wt. % to about 47 wt. % animal skin protein, optionally about 15 wt. % to about 27 wt. % animal skin protein.
3. The edible animal chew according to statement 2 or statement 3, wherein the animal skin protein comprises at least 65 wt. % collagen.
4. The edible animal chew according to any one of the preceding statements, wherein the at least one extruded layer comprises about 0.5 wt. % to about 8 wt. % animal fat, optionally about 2 wt. % to about 4.5 wt. % animal fat.
5. The edible animal chew according to any one of the preceding statements, wherein the at least one extruded layer comprises about 4 wt. % to about 13 wt. % soybean protein, optionally about 7 wt. % to about 11 wt. % soybean protein.
6. The edible animal chew according to any one of the preceding statements, wherein the soybean protein is in the form of a powder, optionally wherein the powder has a d₉₀ of less than 0.15 mm.
7. The edible animal chew according to any one of the preceding statements, wherein the at least one extruded layer further comprises starch, optionally wherein the starch is selected from a native potato starch, a waxy maize starch, an acetylated waxy maize starch, a hydroxypropylated waxy maize starch, an enzyme treated waxy maize starch or a combination thereof.
8. The edible animal chew according to statement 7, wherein the at least one extruded layer comprises about 6 wt. % to about 40 wt. %, optionally from about 10 wt. % to about 15 wt. % starch.
9. The edible animal chew according to any one of the preceding statements, wherein the edible animal chew further comprises an alkyl succinate modified starch.
10. The edible animal chew according to any one of the preceding statements, wherein the at least one extruded layer comprises water, optionally wherein the at least one extruded layer comprises about 5 wt. % to about 25 wt. % water.
11. The edible animal chew according to any one of the preceding statements, wherein the at least one extruded layer edible comprises a plasticizer, optionally wherein the plasticizer is glycerol.
12. The edible animal chew according to statement 11, wherein the at least one extruded layer comprises about 10 wt. % to about 45 wt. % glycerol, optionally about 20 wt. % to about 25 wt. % glycerol.
13. The edible animal chew according to any one of the preceding statements, wherein the at least two extruded layers have a different thickness.
14. The edible animal chew according to any one of the preceding statements, wherein the at least two extruded layers comprise an outer concentric layer and an inner concentric layer.
15. The edible animal chew according to any one of the preceding statements, wherein the outer concentric layer and the inner concentric layer have a circular cross-section.
16. The edible animal chew according to statement 14 or statement 15, wherein the outer concentric layer and the inner concentric layer have a different thickness, and optionally wherein the outer concentric layer has a smaller thickness than the inner concentric layer.
17. The edible animal chew according to any one of the preceding statements, wherein the at least two extruded layers have the same composition.
18. The edible animal chew according to any one of the preceding statements, wherein the edible animal chew has a water activity between about 0.45 to about 0.85, optionally from about 0.50 to about 0.70.
19. The edible animal chew according to any one of the preceding statements, wherein the edible animal chew has a tensile toughness greater than about 200 MPa, optionally about 300 MPa.
20. A process for producing an edible animal chew comprising at least two extruded layers, comprising:
   extruding at least one extrusion composition to form at least two extruded layers, wherein at least one extrusion composition comprises animal skin protein, animal fat and soybean protein, and
   injecting a gas between the at least two extruded layers to form a gap between at least a portion of the two extruded layers,
      wherein the animal skin is porcine or bovine and wherein the animal fat is porcine or bovine.
21. The process for producing an edible animal chew according to statement 20, wherein the extruding step comprises: feeding at least one extrusion composition into an extrusion apparatus; conveying the at least one extrusion composition through the extrusion apparatus, and extruding the at least one extrusion composition through a nozzle.
22. The process for producing an edible animal chew according to any one of statements 20 to 21, wherein the gas is injected at a pressure from about 0.05 bar to about 4 bar.
23. The process for producing an edible animal chew according to any one of statements 20 to 22, wherein the gas is injected in pulses.
24. The process for producing an edible animal chew according to any one of statements 20 to 23, wherein after the injecting step there is a rolling step, wherein the at least two extruded layers are compressed by a rolling assembly.
25. The process for producing an edible animal chew according to any one of the proceeding statements, wherein the extrusion composition is extruded through a nozzle wherein the nozzle comprises:
   at least one extrusion channel that is configured to form at least two extruded layers; and
   at least one gas outlet configured to inject gas between the at least two extruded layers,
   wherein the gas outlet is connected to a gas supply.

1. An edible animal chew comprising at least two extruded layers, wherein at least one extruded layer comprises:
animal skin protein, wherein the animal skin is porcine or bovine,
animal fat, wherein the animal fat is porcine or bovine, and
a plant protein selected from soybean protein and potato protein, wherein there is an air-gap between at least a portion of the at least two extruded layers.

2. An edible animal chew comprising
an extruded composition comprising:
animal skin protein, wherein the animal skin is porcine or bovine,
animal fat, wherein the animal fat is porcine or bovine, and
a plant protein selected from soybean protein and potato protein,
and starch,
wherein the animal skin protein and animal fat together constitute at least 10 wt % of the extruded composition,
the plant protein constitutes at least 10 wt % of the extruded composition, and
the starch constitutes at least 10 wt % of the extruded composition.

3. The edible animal chew according to claim 1, wherein the at least one extruded layer comprises about 7 wt. % to about 47 wt. % animal skin protein.

4. The edible animal chew according to claim 1, wherein the animal skin protein comprises at least 65 wt. % collagen.

5. The edible animal chew according to claim 1, wherein the at least one extruded layer or the extruded composition comprises about 0.5 wt. % to about 8 wt. % animal fat.

6. The edible animal chew according to claim 1, wherein the at least one extruded layer or the extruded composition comprises about 4 wt % to 40 wt % plant protein.

7. The edible animal chew according to claim 1, wherein the at least one extruded layer or the extruded composition comprises about 4 wt % to 40 wt % soybean protein.

8. The edible animal chew according to claim 1, any one of the preceding claims, wherein the at least one extruded layer or the extruded composition comprises about 4 wt % to 40 wt % potato protein.

9. (canceled)

10. The edible animal chew according to claim 1, wherein the at least one extruded layer further comprises starch.

11. (canceled)

12. (canceled)

13. The edible animal chew according to claim 1, wherein the at least one extruded layer comprises a plasticizer.

14. (canceled)

15. The edible animal chew according to claim 1, wherein the at least two extruded layers have a different thickness.

16. The edible animal chew according to claim 1, wherein the at least two extruded layers comprise an outer concentric layer and an inner concentric layer.

17. The edible animal chew according to claim 16, wherein the outer concentric layer and the inner concentric layer have a circular cross-section.

18. The edible animal chew according to claim 16, wherein the outer concentric layer and the inner concentric layer have a different thickness.

19. (canceled)

20. (canceled)

21. (canceled)

22. The edible animal chew according to claim 1, wherein the edible animal chew has a tensile toughness greater than about 200 MPa.

23. A process for producing an edible animal chew comprising at least two extruded layers, comprising:
extruding at least one extrusion composition to form at least two extruded layers, wherein at least one extrusion composition comprises animal skin protein, animal fat and soybean protein, and
injecting a gas between the at least two extruded layers to form a gap between at least a portion of the two extruded layers,
wherein the animal skin is porcine or bovine and wherein the animal fat is porcine or bovine.

24. The process for producing an edible animal chew according to claim 23, wherein the extruding step comprises: feeding at least one extrusion composition into an extrusion apparatus; conveying the at least one extrusion composition through the extrusion apparatus, and extruding the at least one extrusion composition through a nozzle.

25. (canceled)

26. (canceled)

27. The process for producing an edible animal chew according to claim 23, wherein after the injecting step there is a rolling step, wherein the at least two extruded layers are compressed by a rolling assembly.

28. The process for producing an edible animal chew according to claim 23, wherein the extrusion composition is extruded through a nozzle
wherein the nozzle comprises:
at least one extrusion channel that is configured to form at least two extruded layers; and
at least one gas outlet configured to inject gas between the at least two extruded layers,
wherein the gas outlet is connected to a gas supply.

29. (canceled)
